(19) United States
(12) Patent Application Publication
(10) Pub. No.: US 2011/0283062 A1
(43) Pub. Date: Nov. 17, 2011

(54) STORAGE APPARATUS AND DATA RETAINING METHOD FOR STORAGE APPARATUS

(75) Inventors: Naoko Kumagai, Isehara (JP); Tetsuya Abe, Hiratsuka (JP); Azuma Kano, Hiratsuka (JP)

(73) Assignee: HITACHI, LTD., Chiyoda-ku, Tokyo (JP)

(21) Appl. No.: 12/744,958

(22) PCT Filed: May 14, 2010
(86) PCT No.: PCT/JP2010/003266

§ 371 Date: May 27, 2010

(51) Int. Cl. G06F 12/00

(52) U.S. Cl. 711/114; 711/E12.001

(57) ABSTRACT

To enable reduction of the data capacity while inhibiting degradation of read performance.

If any of a plurality of host systems issues a request to write duplicate data as objective data which is identical to already stored data, a processor for a disk controller controls a data transfer control unit so that part of the duplicate data will be kept in accordance with a specific rule instead of entirely eliminating writing of the duplicate data.

### TECHNICAL FIELD

The present invention relates to a storage apparatus and a data retaining method for the storage apparatus. Particularly, this invention is suited for use in a storage apparatus relating to a technique for eliminating the storage of duplicate data.

### BACKGROUND ART

A conventional storage system uses another technique for eliminating duplication of data within a certain logical volume (hereinafter referred to as the Redundancy Elimination technique) in order to curb the amount of duplicated data within the same logical volume (see Patent Literature 1). If such a Redundancy Elimination technique is used, it is possible to maximize data capacity.

### CITATION LIST

### Patent Literature

PTL 1: Japanese Patent Laid-Open (Kokai) Application Publication No. 2009-87021

### SUMMARY OF INVENTION

### Technical Problem

Although the conventional storage system can reduce duplicated data by eliminating the writing of redundant duplicate data, there is a possibility that, in response to multiple read requests for the same data, the seeker head can read only the single stored instance of that data, causing a backlog and slower response times to the multiple read requests.

The present invention was devised in light of the circumstances described above and aims at suggesting a storage system with a data retaining method that can counteract the degradation of read performance and maximize data capacity.

### Solution to Problem

In order to solve the above-mentioned problem, the present invention embodies a storage apparatus comprising: a disk unit equipped with a plurality of storage devices; and a disk controller for providing a plurality of host systems with a logical volume composed of storage areas in the plurality of storage devices; wherein the disk controller includes: a data transfer control unit for transferring objective data to the disk unit in response to write requests from the plurality of host systems and transferring data stored in the disk unit to each of the plurality of host systems; and a processor for controlling the data transfer control unit so that if any of the plurality of host systems issues a write request to write duplicate data as objective data which is identical to the stored data, part of the duplicate data will be kept in accordance with a specific rule instead of entirely eliminating writing of all the duplicate data.

Also, the present invention embodies a data retaining method for a storage apparatus including a disk unit equipped with a plurality of storage devices, and a disk controller for providing a plurality of host systems with a logical volume composed of storage areas in the plurality of storage devices is characterized in that the data retaining method includes: a data transfer control step executed by a processor for the disk controller for transferring objective data to the disk unit in response to write requests from the plurality of host systems and transferring data stored in the disk unit to each of the plurality of host systems; and a control step executed by the processor for the disk controller for executing the data transfer control step so that if any of the plurality of host systems issues a write request to write duplicate data as objective data which is identical to the stored data, part of the duplicate data will be kept in accordance with a specific rule instead of entirely eliminating writing of the duplicate data.

### Advantageous Effects of Invention

This invention can inhibit degradation of read performance and reduce the data capacity.

### BRIEF DESCRIPTION OF DRAWINGS

FIG. 1 shows the concept of the first embodiment.

FIG. 2 is a block diagram showing the schematic configuration of a storage system in the first embodiment.

FIG. 3 is a block diagram showing a configuration example for a storage apparatus in the first embodiment.

FIG. 4 is a diagram showing an example of the corresponding relationship between virtual pages and real pages assigned to written areas.

FIG. 5 is a diagram showing an example of the corresponding relationship between virtual pages and real pages assigned to written areas.

FIG. 6 is a diagram showing an example of a logical volume management table.

FIG. 7 is a diagram showing an example of a redundancy management information table.

FIG. 8 is a diagram showing an example of a redundancy elimination judgment table.

FIG. 9 is a diagram showing an example of a pool management table.

FIG. 10 is a flowchart showing an example of a data writing method.

FIG. 11 is a flowchart showing an example of a data reading method.

FIG. 12 is a diagram showing an example of a redundancy management information set table.

FIG. 13 is a flowchart showing an example of redundancy judgment processing.

FIG. 14 is a diagram showing a specific example of a first redundancy judgment procedure.

FIG. 15 is a diagram showing an example of how to update the redundancy management information table.

FIG. 16 is a diagram showing an example of a second redundancy judgment procedure.

FIG. 17 is a diagram showing an example of how to update the redundancy management information table.

FIG. 18 is a diagram showing a method of applying a first policy for inhibiting Redundancy Elimination processing.

FIG. 19 is a diagram showing a method of applying a second policy for inhibiting Redundancy Elimination processing.

FIG. 20 is a flowchart illustrating a first example of redundancy judgment processing.

FIG. 21 is a flowchart illustrating a second example of the redundancy judgment processing.

FIG. 22 is a flowchart illustrating a third example of the redundancy judgment processing.

FIG. 23 is a flowchart illustrating a fourth example of the redundancy judgment processing.

FIG. 24 is a diagram showing an example of the concept of a second embodiment.

FIG. 25 is a diagram showing the schematic configuration of a storage system in the second embodiment.

FIG. 26 is a sequence chart showing an example of application to backup restoration.

FIG. 27 is a sequence chart showing an example of cooperation with backup software.

FIG. 28 shows an example of load on the number of areas when using high-speed media and low-speed media.

FIG. 29 is a block diagram showing a configuration example for a storage system that adopts dynamic hierarchical control.

FIG. 30 is a diagram showing an example of a pool attribute table that shows the correspondence relationship of pool attributes for each pool number.

FIG. 31 shows an example of a data writing method corporatively using Dynamic Control and Redundancy Elimination.

### DESCRIPTION OF EMBODIMENTS

An embodiment of the present invention will be described below in detail with reference to the attached drawings.

### (1) Configuration of Storage System in the Present Embodiment

(1-1) Concept of the Present Embodiment

A storage apparatus in the present embodiment uses a technique called Thin Provisioning that virtualizes and allocates storage resources, as a premise. The use of such a technique enables the storage apparatus to provide a host system with virtual logical volumes (hereinafter referred to as virtual volumes) with a larger capacity than the capacity of the physical disk, yet allows the extra capacity to be actually used merely by installing an additional physical disk. This technique can also be used to preemptively increase the capacity of resources by adding a physical disk.

A storage apparatus in the present embodiment uses the above-described Thin Provisioning technique and also uses Redundancy Elimination control to eliminate writing of identical data to virtual volumes. This storage apparatus stores data from a host system in its virtual volumes and maps it in segments in the virtual volumes. When doing so, the above-mentioned Redundancy Elimination technique judges whether or not the new data is identical to data stored in any of the segments. If the new data is not duplicate data, that data is written to the virtual volumes; and if the new data is identical to tha data stored in the segment, the data is not written to the virtual volumes in principal. With this arrangement, the storage apparatus makes the host system read the data from the host system unless another indetical new data is written to the virtual volumes.

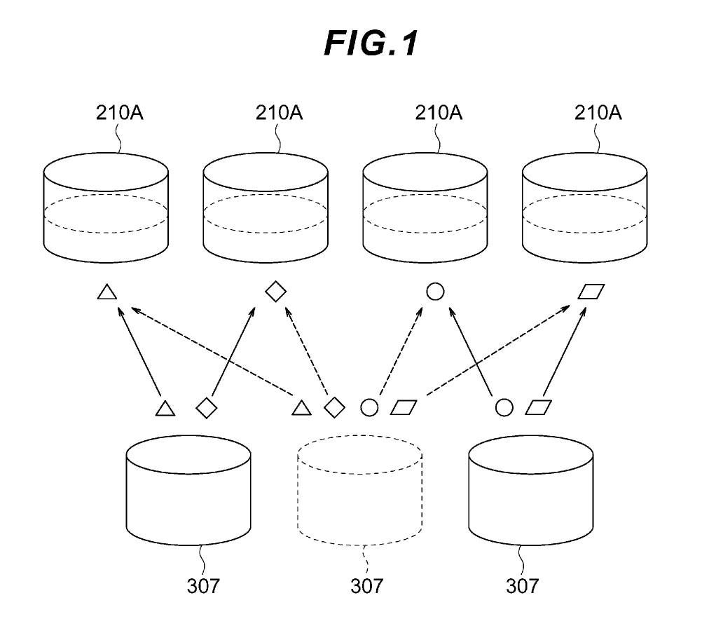

FIG. 1 shows the simplified concept of a storage apparatus in the first embodiment. This first embodiment uses the above-mentioned Redundancy Elimination control and also aims at the flexible operation of the Redundancy Elimination control under certain conditions with the viewpoint of avoiding access jams particularly when there are multiple read requests for the same data, thereby improving the efficiency in data reading.

Specifically, if a write request is issued to write objective data which is identical to data already in the virtual volumes (hereinafter referred to as the duplicate data), the amount of duplicate data actually re-written is controlled pursuant to a specific rule, instead of simply ceasing the writing of all the duplicate data. In ideal cases, the writing of duplicate data is permitted to some degree and the method of storing the duplicate data is also controlled. This concept will be explained in more detail below.

(1-2) Configuration of Storage System

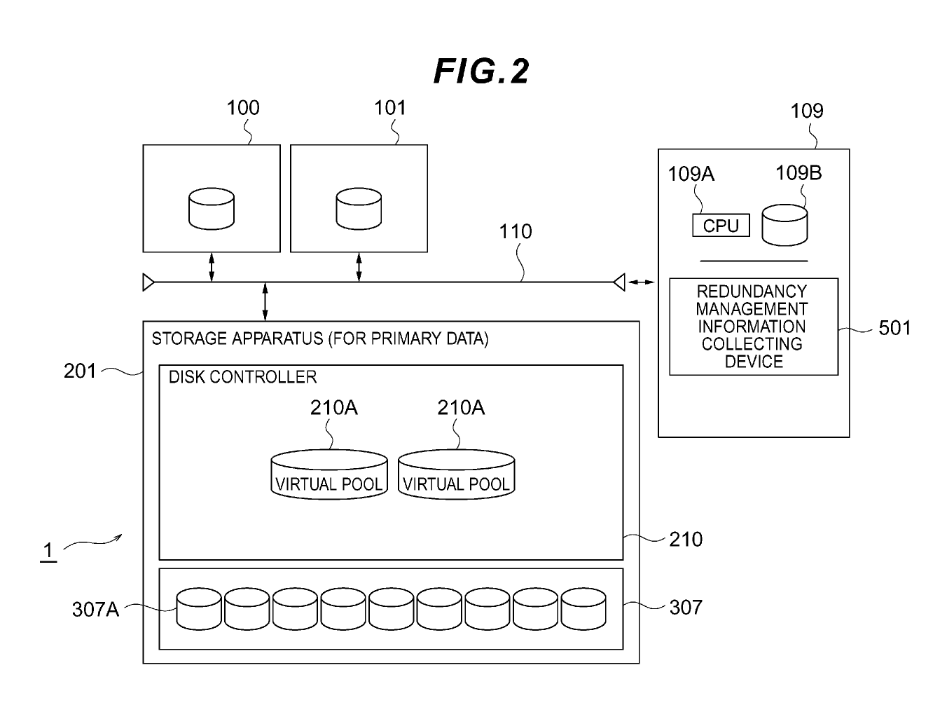

FIG. 2 shows the schematic configuration of a storage system 1 in the first embodiment. The storage system 1 is configured so that file servers 100, 101 and a storage apparatus 201 are connected to a network 110; and a management server 109 may be also included. Each file server 100, 101 issues a data write request to the storage apparatus 201 and then writes data to the storage apparatus 201; and the file servers also sends a data read request to read data stored in a volume 307A and then reads data from the volume 307A. The details of the storage apparatus 201 will be explained later.

The management server 109 includes a CPU (hereinafter referred to as the processor) 109A, a storage device 109B, and a redundancy management information collecting device 501. The redundancy management information collecting device 501 has a function that collects specified information (hereinafter referred to as the redundancy management information) from each of the plurality of file servers 100, 101. This redundancy management information is management information for managing whether data to be written by the file server 100, 101 and already stored data are redundant or not. Incidentally, if there is one file server 100, the management server 9 may have a disk controller 210 substituted for the function of the redundancy management information collecting device 501, so that the redundancy management information collecting device 501 may be omitted.

The storage apparatus 201 shown in the drawing is, for example, a storage apparatus for primary data and includes the disk controller 210 and a disk unit 307. The disk unit 307 provides virtual volumes corresponding to storage areas in many storage devices. These virtual volumes are associated with virtual pools. The disk controller for primary data will be hereinafter also simply referred to as the disk controller. The storage apparatus 201 uses a so-called RAID (Redundant Arrays of Independent Disks) configuration as described later.

The disk controller 210 has three functions as described later, that is, virtual pool management (data placement), Redundancy Elimination (analysis and execution), and access statistical analysis. The disk controller 210 provides at least one virtual pool 210A by exercising the aforementioned virtual pool management function. Regarding the above-mentioned Redundancy Elimination function, the disk controller 210 analyzes write data in accordance with a specific rule (hereinafter referred to as the Redundancy Elimination rule) described later and executes the Rredundancy Elimination function as necessary. Regarding the above-mentioned access statistical analysis function, the disk controller 210 obtains access statistics about specific data stored in a segment of a volume and performs analysis based on the result. These three functions will be explained later.

In the present embodiment, the disk controller 210 has a data placement map, a data redundancy counter, and data access frequency information. The data placement map (explained later in detail) is a map indicating data placement. This data placement map will be explained about the correspondence relationship between each pool described later and the RAID group. The data redundancy counter (explained later in detail) measures redundancy frequency of accesses to each piece of data. The data access frequency information is information about the number of accesses to each piece of data. The details of the data placement map and others will be explained later.

(1-3) Configuration of Storage Apparatus

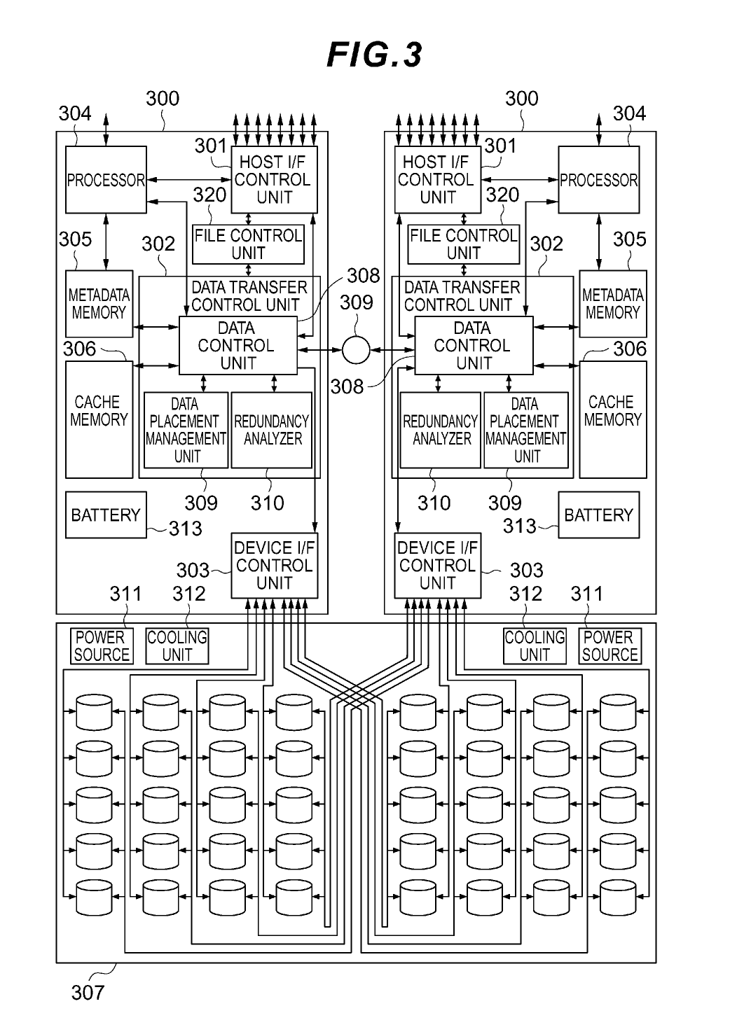

FIG. 3 shows a configuration example for the storage apparatus 201 in first present embodiment. The storage apparatus 201 includes two disk controllers 300 and the disk unit 307. The two disk controllers 300 are connected via an inter-controller connector 309 so that they transfer data to each other to duplicate this data as described later. Incidentally, the two disk controllers 300 have almost the same configuration, so only one of them will be explained.

The disk controller 300 includes a host I/F control unit 301, a processor 304, a metadata memory 305, a data transfer control unit 302, a cache memory 306, a device I/F control unit 303, and a battery 313. The battery 313 supplies electric power to each element such as the processor 304. Incidentally, the storage apparatus 201 may include a file control unit 320.

The file control unit 320 realizes, for example, a simplified file server function. Specifically speaking, the file control unit 320 converts a file-format file into data and converts data into a file-format file. A method for the storage apparatus equipped with the file control unit 320 in the present embodiment is also called a file control method. To the contrary, a method for the storage apparatus not equipped with the file control unit 320 in the present embodiment is also called a block control method. The following explanation will mainly focus on the block control method, but the file control method will be also explained as the need arises.

The host I/F control unit 301 is an interface for transferring data or files to/from a host system such as the file server 100, 101. The processor 304 controls the host interface control unit 301 and the data transfer control unit 302, while exchanging information with the metadata memory 305. The metadata memory 305 stores any of, or a combination of any of, a logical volume management table, redundancy elimination management table, redundancy elimination judgment table, pool management table, and pool attribute table described later. It should be noted that these tables may be stored in the cache memory 306.

The data transfer control unit 302 includes a data control unit 308, a data placement management unit 309, and a redundancy analyzer 310. The data control unit 308 controls the entire data transfer control unit 302 as well as the device I/F control unit 303 under the control of the processor 307.

This data control unit 308 transfers data to or from the data control unit 308 for the other disk controller 300 via the inter-controller connector 309. As a result, the storage apparatus 201 can duplicate and retain the same data. The data placement management unit 309 manages the aforementioned data placement map according to the placement of each piece of data. The redundancy analyzer 310 performs redundancy analysis under the control of the processor 304 to judge whether write data is identical to duplicate data or not, and then generates the aforementioned data access frequency information. Incidentally, the present embodiment will be described by expressing, for ease of explanation, that the processor 304 performs redundancy analysis by the redundancy analyzer 310.

The cache memory 306 is a memory for temporarily storing data to be transferred to or from the data control unit 308. The device I/F control unit 303 transfers data to or from the disk unit 307 under the control of the data control unit 308.

(1-4) Correspondence Relationship Between Plurality of Virtual Pools and Raid Groups

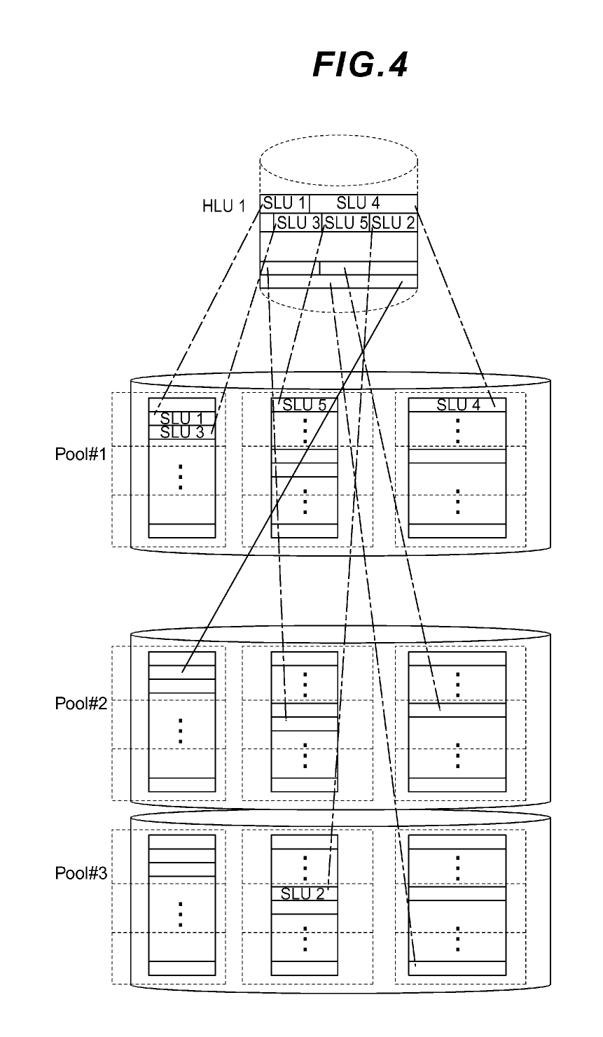

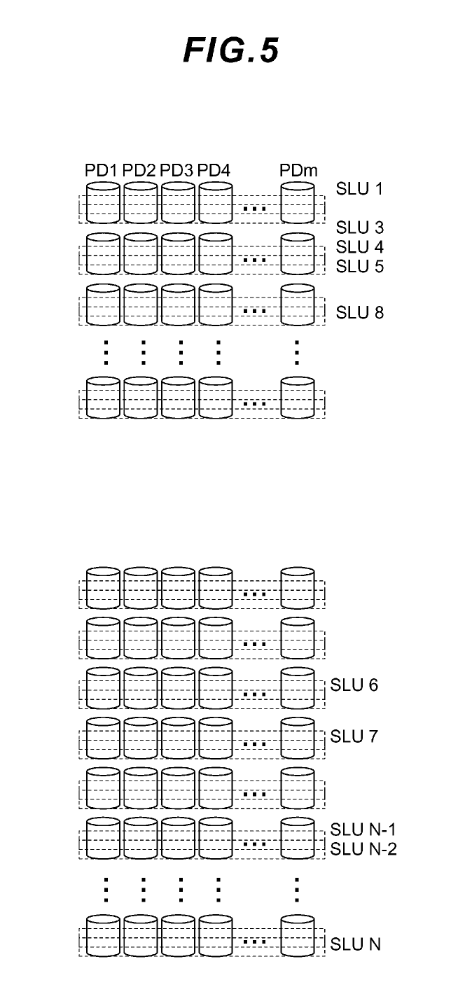

FIG. 4 and FIG. 5 show an example of the correspondence relationship between virtual pages and real pages assigned to written areas. This correspondence relationship corresponds to the aforementioned data placement map.

FIG. 4 shows the correspondence relationship between logical volumes on the host side shown with a short dashed line in an upper part of the drawing (hereinafter referred to as the host LU or HLU) and logical volumes on the storage apparatus side shown with a solid line in a lower part of the drawing (hereinafter referred to as the storage LU or SLU), using an alternate long and short dashed line.

Each storage LU in each virtual pool shown in the lower part, whose pool number is 1 to 3 (corresponding to Pool #1 to #3 in the drawing) is mapped for, for example, each segment like the host LU in the logical volume shown in the upper part. Incidentally, each virtual pool is composed of a plurality of virtual pages. The virtual volume like as shown in the upper part is composed of a plurality of HLUs which are mapped as described above.

FIG. 5 shows an example of the correspondence relationship between a plurality of virtual pools and RAID groups registered in each virtual pool. This correspondence relationship corresponds to the aforementioned data placement map. The example shown in the drawing illustrates the correspondence relationship between logical volumes on the storage apparatus side (SLUs) and mapped physical logical volumes (PLUs).

Conversion processing is further needed in order to recognize where in the physical volumes (PLUs) in physical disks (corresponding to PD1 to PDm described later) the relevant data actually exists. One stripe is formed so that it extends across the physical disks PD1 to PDm. Each stripe corresponds to any of the aforementioned storage LUs (SLU1 to SLUN). As described above, FIG. 4 and FIG. 5 show the correspondence relationship between the three types of volumes, that is, the host LUs, the storage LUs, and the PLUs. These three types of volumes are mapped so that their mutual positional relationship can be seen in an example as shown in the drawings.

Since such mapping correspondence relationship exists in the present embodiment, a Logic to Logic conversion is executed between the host LUs and the storage LUs, and a Logic to Physical conversion is also executed between the storage LUs and the PLUs. Incidentally, the above-described pool concept is introduced to the relationship between them instead of directly associating the host LUs with the PLUs, so that the necessity of adjusting the capacity of each physical disk can be minimized as much as possible by inhibiting uneven distribution of data storage positions by the PLUs; and the unused capacity of each physical disk corresponding to each PLU is made as equal as possible and useless areas in each physical disk are compressed; as a result, the plurality of physical disks can be utilized efficiently. Incidentally, the above-described method of filling the physical disks PD1 to PDm with data not disproportionately as described above is also called Round Robin (method) in the present embodiment.

Furthermore, the RAID configuration is used as described above in the present embodiment and at least one stripe formed to extend across the physical disks PD1 to PDm as shown in FIG. 5 corresponds to one RAID group.

(1-5) Logical Volume Management Table

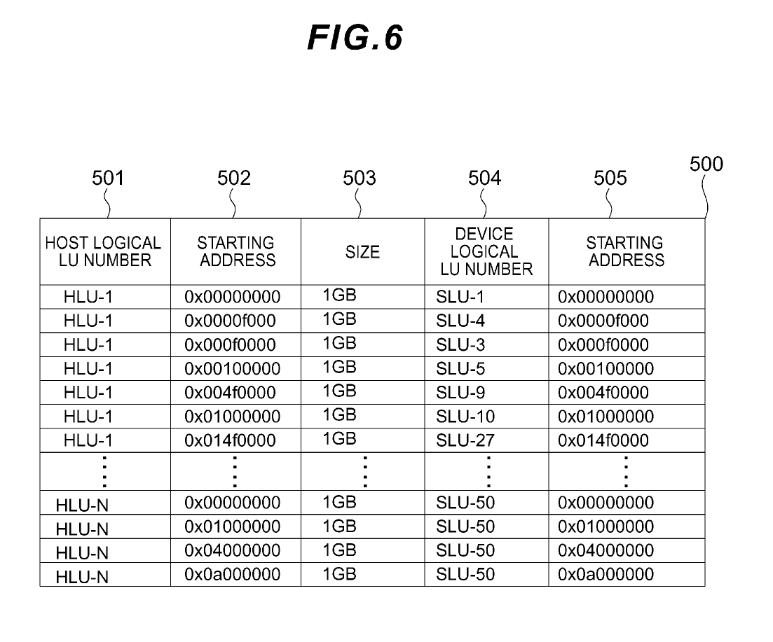

FIG. 6 shows an example of a logical volume management table 500. The logical volume management table 500 manages an address map in which an aggregate of virtual volumes (corresponding to virtual volumes) on the host side is managed by dividing the aggregate into individual volume. The logical volume management table 500 manages each virtual volumes based on the concept that each virtual volume can be defined by its starting address and size. Incidentally, FIG. 6 shows the correspondence relationship between the host LUs (host logical LUs) and the storage LUs shown in FIG. 4 described above.

The logical volume management table 500 has, as its entries, a host logical LU (Logical Unit) number, starting address 502, size 503, device logical LU number 504, and starting address 505. The host logical LU number is an identifier for identifying the aforementioned host LU and the starting address 502 is a leading address of the relevant host LU. The size 503 is the data capacity of the virtual volume. The device logical LU number is an identifier for identifying the relevant storage LU and the starting address 502 is a leading address of the storage LU.

(1-6) Redundancy Management Information Table

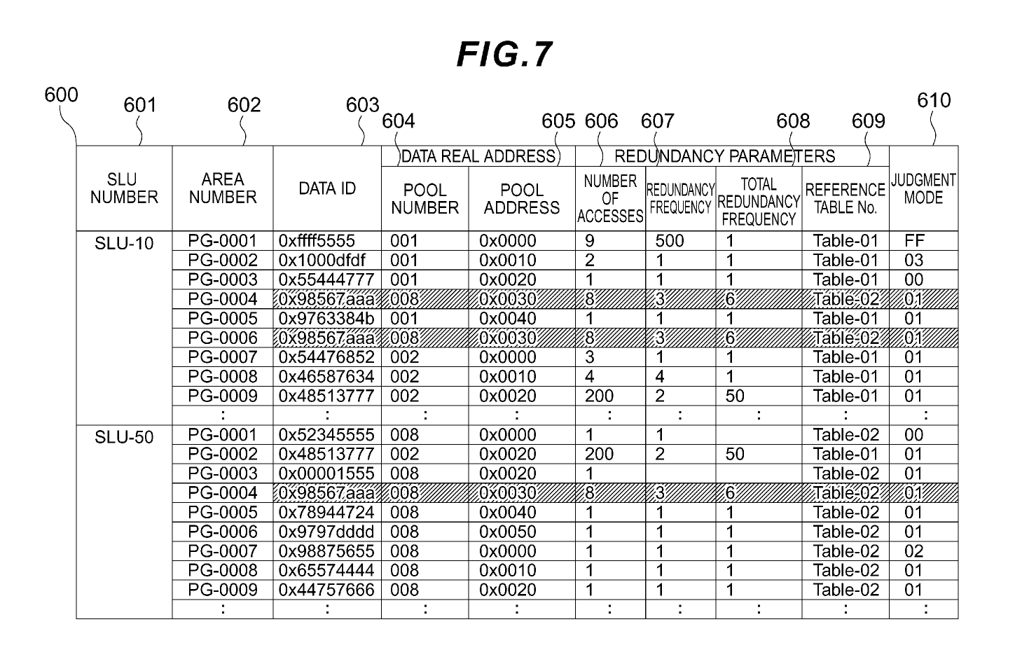

FIG. 7 shows an example of a redundancy management information table 600. The redundancy management information table 600 manages the relationship between each virtual pool shown in the lower part of FIG. 4 and the PLUs in the physical disks shown in FIG. 5. The redundancy management information table 600 primarily manages data boundaries and redundancy frequency. This redundancy frequency is measured by the aforementioned data redundancy counter 221. Specifically speaking, the redundancy management information table 600 manages, for each SLU number 601, an area number 602, data ID (Identifier) 603, real data address, redundancy parameters, and judgment mode 610. The area number 602 is the number for identifying each virtual pool. The data ID (Identifier) 603 is an identifier for identifying each piece of data.

The aforementioned real data address includes a pool number 604 and a pool address 605. If one storage LU is developed across a plurality of virtual pools, the pool number 604 is the number used to manage the correspondence relationship between these virtual pools. If such pool number 604 is introduced and certain data is stored by determining the location, that data can be migrated in small units. The pool address 605 indicates the address in each virtual pool.

The aforementioned redundancy parameters relate to hash algorithm described later and include the number of accesses 606, redundancy frequency 607, total redundancy frequency 607, and a reference table 609. The number of accesses 606 indicates a total number of times a request to access each piece of data is issued. The redundancy frequency 607 indicates the number of redundant accesses to each piece of data and is rest to 0 according to a value of the total redundancy frequency 607 described below. The total redundancy frequency 607 indicates the total number of accesses to the relevant data after the redundancy frequency 607 is reset. The reference table 609 is information about what kind of Redundancy Elimination mode should be used or whether any specified redundancy parameter is needed or not if a certain Redundancy Elimination mode is used.

The judgment mode 610 indicates the following matters according to the content of Redundancy Elimination settings. Firstly, FF represents forced Redundancy Elimination. 00 represents prohibition of Redundancy Elimination. 01 represents that whether the Redundancy Elimination should be performed or not is judged based on thresholds for the number of accesses 606 and the total redundancy frequency 607. 02 represents that redundancy is permitted until the N-th time. 03 represents that redundancy is permitted every M+1-th time. Incidentally, M is an integer. As a result, what kind of Redundancy Elimination should be performed is determined for every block in each piece of data. The content of what kind of Redundancy Elimination should be performed is expressed as a &policy& in the present embodiment.

(1-7) Redundancy Elimination Judgment Table

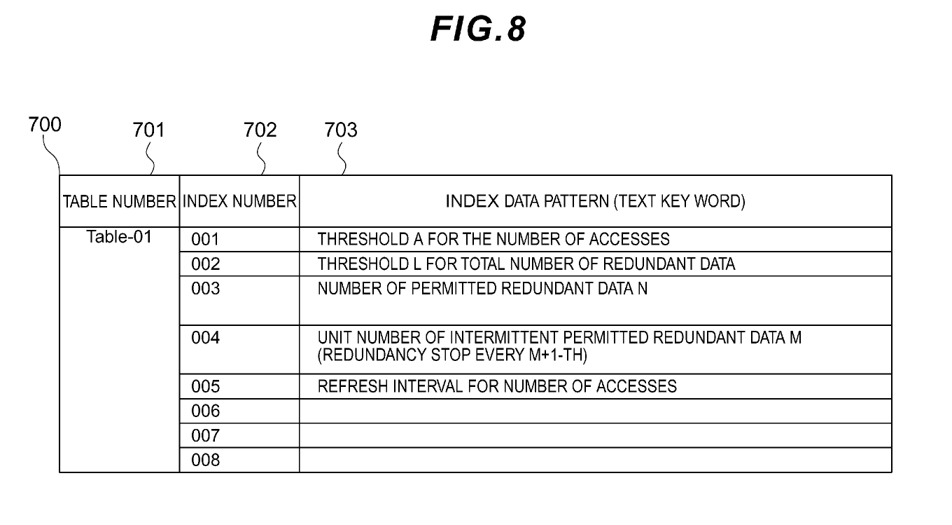

FIG. 8 shows an example of a redundancy elimination judgment table 700. The redundancy elimination judgment table 700 manages an index number and an index data pattern for each reference table corresponding to a table number 701. The table number 701 corresponds to the aforementioned the reference table number 609. The index number is the number for identifying an index data pattern representing the type of data. The redundancy elimination judgment table 700 is a table used to understand the content of the policy described below by referring to the corresponding redundancy parameter(s) if the objective data matches a certain index data pattern.

The index data pattern is a text keyword(s). For example, threshold A for the number of accesses is 10, threshold L for the total number of duplicate data is 50, and the number of permitted duplicate data N is 3. Incidentally, the above value means that if the number of permitted duplicate data is N+1 or more (that is, 4 or more), Redundancy Elimination control will be executed. Furthermore, for example, the unit number of intermittent permitted duplicate data M is 10. Incidentally, the above value means that redundancy stop control will be executed every M+1-th time of the unit number of intermittent permitted duplicate data. For example, a refresh interval for the number of accesses is 30 days.

(1-8) Pool Management Table

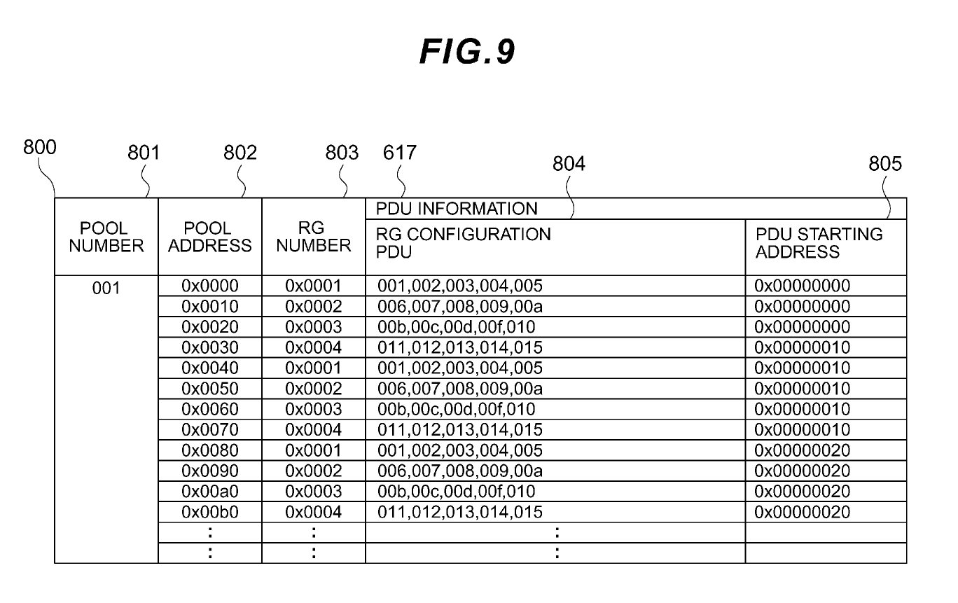

FIG. 9 shows an example of a pool management table 800. The pool management table 800 shows an image of conversion between the storage LUs and the PLUs and is a table for associating, for example, each virtual pool, RAID groups (hereinafter sometimes simply referred to as RG), and physical disks with each other. The pool management table 800 manages, for each pool number 801, a pool address 802, RG number 803, and physical disk unit (PDU) information 617.

This pool management table 800 manages information about where a certain storage LU should be located at which pool address in which virtual pool. The PDU information 617 includes an RG configuration PDU 804 and a PDU starting address 805. The RG configuration PDU 804 indicates which physical disks are included in each RAID group. Regarding the PDU starting address 805, the pool address 802 used for the virtual pool corresponding to the pool number 801 and the RG number 803 corresponding to that pool address 802 are stored sequentially in the physical disks PD1 to PDm.

During the sequential storage described above in the present embodiment, it is intended to evenly, not disproportionately, store data in the physical disks PD1 to PDm and this method is called round robin. As a result, data is distributed to a plurality of physical disks PD1 to PDm, thereby enhancing the performance as pools. This is because data is managed not by each volume, but by each physical disk PD1 to PDm.

(1-9) Data Retaining Method for Storage Apparatus

The storage system 1 including the storage apparatus 201 in the present embodiment is configured as described above. Next, an example of a data retaining method for the storage apparatus 201 will be explained.

(1-9-1) Data Writing

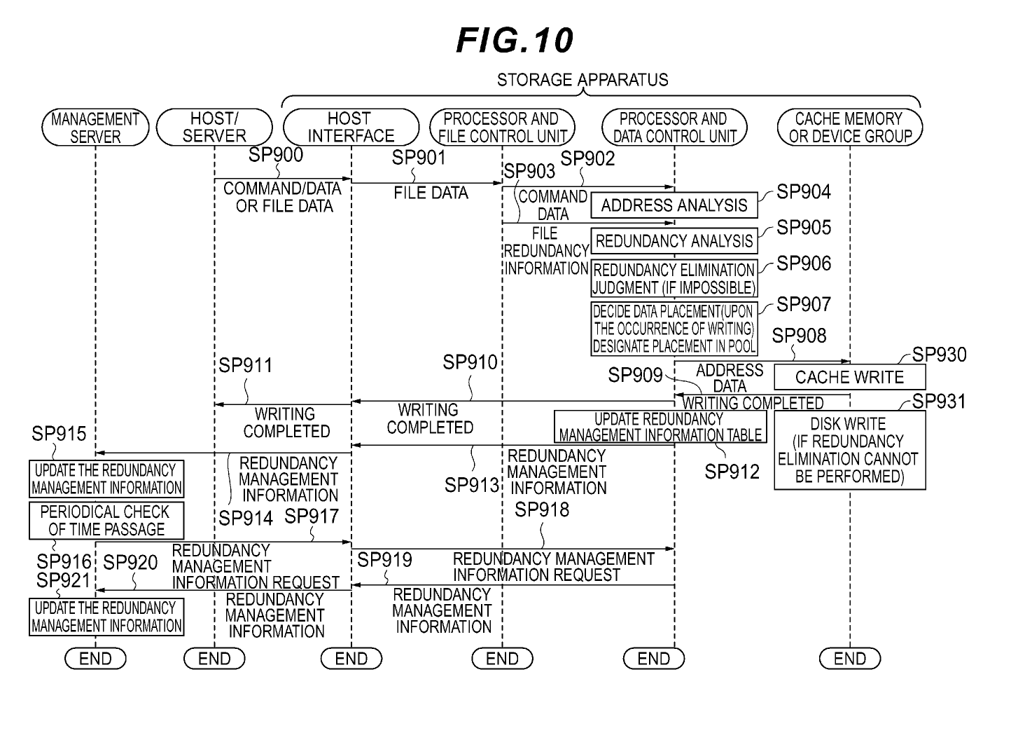

FIG. 10 shows an example of a data writing method. Incidentally, a host/server in the drawing indicates the file server 100, a host interface in the drawing indicates the aforementioned host interface control unit 301, and a device group in the drawing indicates a storage device group in the disk unit 307. The illustrated example in FIG. 10 shows the passage of time as it goes downwards in a vertical direction.

For example, the file server 100 sends a command/data in a case of the block control method or file data in a case of the file control method to the host interface control unit 301 mounted in the disk controller 210 for the storage apparatus 201 via the network 110 (SP900). Incidentally, file-format data is expressed as file data and data which is not in the file format is expressed simply as data in the present embodiment, and procedures for the file control method and the block control method are mixed in flows shown in, for example, FIG. 10.

In the case of the file control method, the host interface control unit 301 delivers the file data to the processor 304 and the file control unit 320 (SP901). The file control unit 320 changes the file data to a command/data and delivers the command/data to the data control unit 308 for the data transfer control unit 302 (SP902). On the other hand, in the case of the block control method, the host interface control unit 301 directly delivers the aforementioned command/data to the data control unit 308 without the intermediary of the file control unit 320 (SP902).

The processor 304 performs address analysis to interpret the address of the delivered objective data (SP904). In the case of the file control method, the processor 304 has received file redundancy information in file units provided by the file control unit 320 in advance (SP903).

Next, the processor 304 performs redundancy analysis (SP905). In this redundancy analysis, the processor 304 judges whether or not the data ID corresponding to the objective data exists in the redundancy management information table 600. If the corresponding data ID exists, the processor 304 collates the SLU number corresponding to that data ID and analyzes the number of accesses and the redundancy relating to that data. When the above procedure is performed, a method of searching for duplicate data utilizing the hash algorithm using, for example, a hash value can be adopted as a method for the redundancy analysis. As a result, it is possible to analyze whether the objective data itself is duplicate data or not (whether data at the same position already exists or not), and the duplication number of the objective data.

Next, if data has not been written to the device group, the processor 304 performs Redundancy Elimination judgment (SP906). If the duplicate data exists, this Redundancy Elimination judgment is performed to judge, in accordance with a set policy, whether the Redundancy Elimination should be cancelled immediately, or whether the Redundancy Elimination should be cancelled after accumulating data to a certain degree. Next, the processor 304 determines the data placement (SP907).

Subsequently, the processor 304 controls the data control unit 308 and delivers the above data and its address to the cache memory 306 and the device group (hereinafter referred to as the cache memory 306 and others) (SP908). The cache memory 306 and others execute cache write (SP930) and the data control unit 308 receives a notice of completion of writing (hereinafter referred to as the write completion notice) from the cache memory 306 and others (SP909). If the Redundancy Elimination cannot be performed (in a case where the judgment mode is 00), the processor 304 has the data control unit 308 control the device I/F control unit 303 and executes writing (disk write) to the volume 307A in the disk unit 307 (SP931).

After receiving the write completion notice, the data control unit 308 sends the write completion notice to the host interface control unit 301 (SP910). The host interface control unit 301 sends the write completion notice to the file server 100 (SP911).

Meanwhile, after the data control unit 308 sends the write completion notice to the host interface control unit 301 as described above, the processor 304 updates the redundancy management information table 600, using the data ID as a key (SP912).

Next, the data control unit 308 delivers the redundancy management information to the host interface control unit 301 (SP913). Incidentally, the host interface control unit 301 may send this redundancy management information to, for example, the management server 109 (SP914). If the redundancy management information is sent to the management server 109 as described above, even if the redundancy management information on the storage apparatus 201 side is destroyed, it is possible to restore the redundancy management information.

In the management server 109, the redundancy management information collecting device 501 updates the redundancy management information (SP915). The redundancy management information includes information about the aforementioned data placement map, the redundancy counter, and the access frequency.

In the present embodiment, the management server 109 may execute the following periodic processing instead of the execution of steps SP913, SP914, SP915 as described above. Specifically speaking, in the management server 109, the redundancy management information collecting device 501 periodically checks the passage of time (SP916). The redundancy management information collecting device 501 for the management server 109 requests redundancy management information from the host interface control unit 301 for the storage apparatus 201 (SP917). The host interface control unit 301 requests the redundancy management information from the data transfer control unit 302 (SP918). The data transfer control unit 302 delivers the redundancy management information to the host interface control unit 301 (SP919). The host interface control unit 301 then delivers this redundancy management information to the management server 109 (SP920). In the management server 109, the redundancy management information collecting device 501 updates the redundancy management information (SP921).

(1-9-2) Data Reading

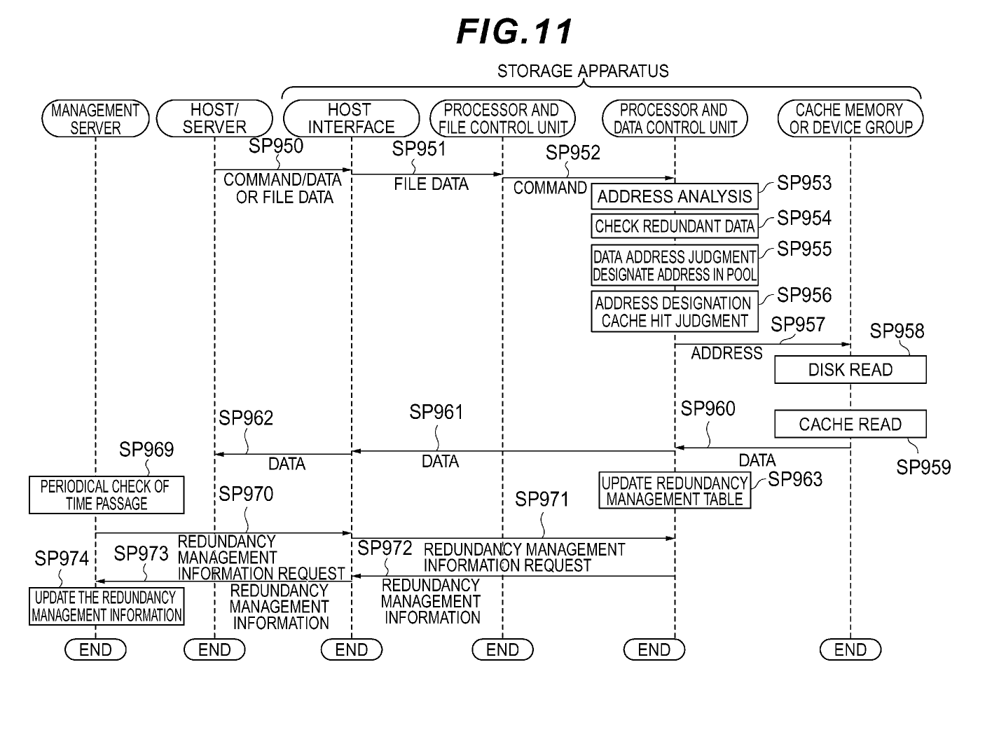

FIG. 11 shows an example of a data reading method. Incidentally, a host/server in the drawing indicates the file server 100, a host interface in the drawing indicates the aforementioned host interface control unit 301, and a device group in the drawing indicates a storage device group in the disk unit 307. The illustrated example in FIG. 11 shows the passage of time as it goes downwards in a vertical direction.

For example, the file server 100 sends a command/data in a case of the block control method or file data in a case of the file control method to the host interface control unit 301 mounted in the disk controller 210 for the storage apparatus 201 via the network 110 (SP950).

In the case of the file control method, the host interface control unit 301 delivers the file data to the processor 304 and the file control unit 320 (SP951). The file control unit 320 issues a command to the data control unit 308 (SP952).

The processor 304 performs address analysis to interpret the address of the delivered objective data (SP953). The processor 304 checks whether or not duplicate data exists in the redundancy management information table 600, by using the data ID of the objective data as a search key (SP954). The processor 304 performs data address judgment on the objective data and designates an address in the aforementioned virtual pool (SP955). The processor 304 performs cache hit judgment by designating the address (SP956). The processor 304 controls the data control unit 308 and notifies the cache memory 306 and others of the address (SP957).

The cache memory 306 and others execute disk read (SP958). Next, the cache memory 306 and others execute cache read (SP959).

The data control unit 308 receives data from the cache memory 306 and others (SP960). The data control unit 308 delivers the data to the host interface control unit 301 and updates the redundancy management information table 600 to update the number of accesses corresponding to the data ID of the objective data (SP963). The host interface control unit 301 sends that data to the file server 100 as the host (SP962).

In the present embodiment, the management server 109 may periodically collect the redundancy management information as described below instead of the execution of steps SP961, SP962 above.

In the management server 109, the redundancy management information collecting device 501 periodically checks the passage of time (SP969). The redundancy management information collecting device 501 for the management server 109 requests redundancy management information from the host interface control unit 301 for the storage apparatus 201 (SP970). The host interface control unit 301 requests the redundancy management information from the data transfer control unit 302 (SP971).

The data transfer control unit 302 delivers the redundancy management information to the host interface control unit 301 (SP972). The host interface control unit 301 then delivers this redundancy management information to the management server 109 (SP973). In the management server 109, the redundancy management information collecting device 501 updates the redundancy management information in a redundancy management information set table 1000 (SP974).

(1-10) Redundancy Management Information Set Table

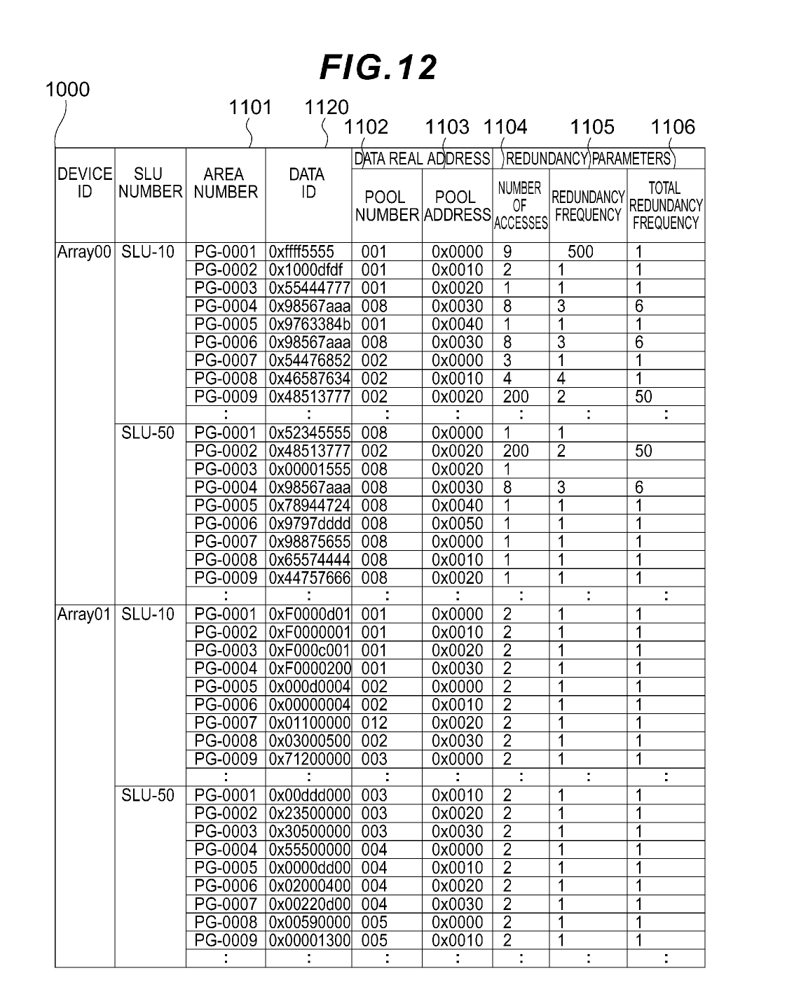

FIG. 12 shows an example of the redundancy management information set table 1000 for the management server 109. The redundancy management information set table 1000 manages the redundancy management information about the storage apparatus 201 and others in a unified manner. Incidentally, if the management server 109 is not provided in the storage system 1, this redundancy management information set table 1000 may be omitted by mounting a similar table on the storage apparatus 201.

The redundancy management information set table 1000 manages many kinds of information in addition to the content of the aforementioned redundancy management information table 600. The redundancy management information set table 1000 manages, for each device ID (Identifier), an SLU number 1100, area number 1101, data ID 1120, real data address, and redundancy parameters. The device ID herein used is an identifier for distinguishing each storage apparatus when a plurality of storage apparatuses like the storage apparatus 201 exist. The real data address includes a pool number 1102 and a pool address 1103. The redundancy parameters include the number of accesses 1104, redundancy frequency 1105, and total redundancy frequency 1106. The SLU number 1100 is the number for distinguishing among the plurality of SLUs.

(1-11) Redundancy Judgment Processing (when Number of Accesses and Redundancy Frequency are Used)

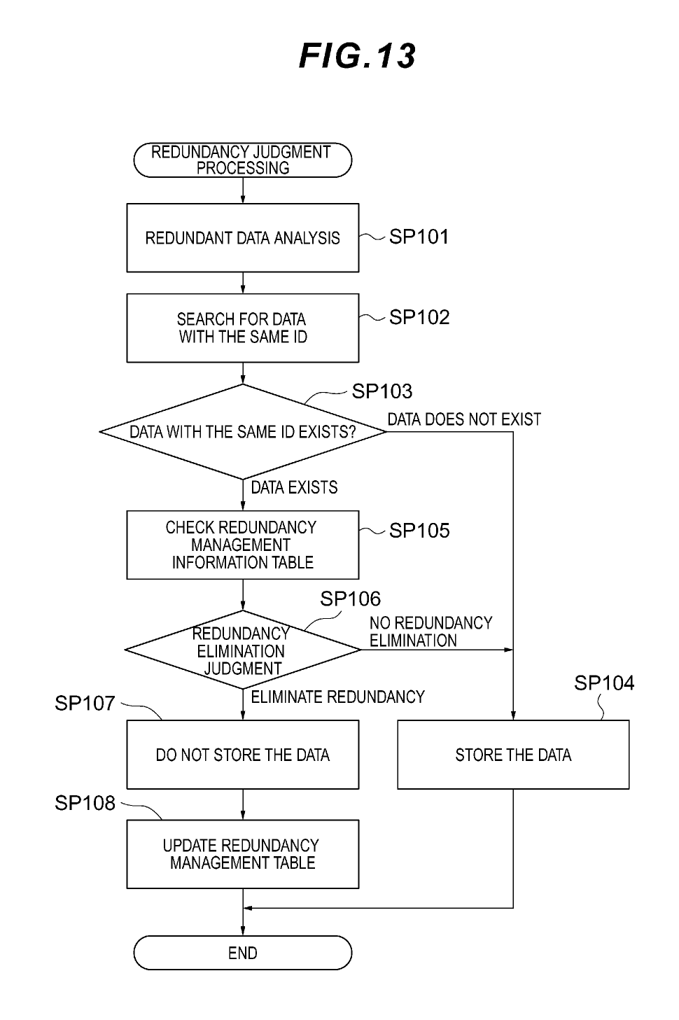

FIG. 13 shows an example of redundancy judgment processing. This redundancy judgment processing is executed by the data control unit 308 under the control of a program in the processor 304. When the program in the processor 304 controls or executes processing, it will be expressed as the processor 304 controls or executes the processing.

Firstly, after the data control unit 308 receives objective data in a specified management unit (for example, in a segment unit) through the intermediary of the host interface control unit 301, the processor 304 analyzes duplicate data (corresponding to the aforementioned redundancy analysis) and calculates the data ID (corresponding to the ID in the drawing) of the objective data (SP101). The processor 304 searches for data with the same data ID (SP102) and judges whether data with the same data ID exists or not (SP103).

If no duplicate data exists, the processor 304 controls the data control unit 308 and stores this data in a device group such as the disk unit 307 (SP104), and then terminates the redundancy judgment processing. On the other hand, if the duplicate data exists, the processor 304 checks the redundancy management information table 600 (SP105).

The redundancy management information table 600 is checked in this step in order for the processor 304 to judge whether or not the aforementioned Redundancy Elimination may be executed unconditionally on the objective data with that data ID. This judgment is made so that flexible control can be performed to not execute the Redundancy Elimination on highly-duplicate data and to execute the Redundancy Elimination on data which is not highly redundant.

Specifically, the processor 304 firstly checks the judgment mode and then checks the redundancy parameters (such as each threshold for the number of accesses and the total redundancy frequency). Specifically speaking, the processor 304 controls to what degree the Redundancy Elimination should be regulated, according to the policy described later by a judgment method decided depending on the relevant judgment mode, for example, according to the result of comparison between a value of the relevant redundancy parameter and a threshold for the redundancy parameter. By using such a combination of the judgment mode and the redundancy parameter, it is possible provide a wide variety of Redundancy Elimination variations with regard to the regulation of the Redundancy Elimination.

If data has not been written to the device group, the processor 304 performs the aforementioned Redundancy Elimination (SP106). Meanwhile, if the Redundancy Elimination is not performed, the processor 304 executes the aforementioned SP104 and then terminates this redundancy judgment processing. On the other, if the Redundancy Elimination is performed, the processor 304 does not store the objective data in the device group (SP107).

The processor 304 updates the redundancy management information table 600 (SP108) and terminates the redundancy judgment processing. When this happens, the processor 304 updates the redundancy management information table 600 to, for example, increment the redundancy frequency 607 by +1 and increment the total redundancy frequency 608 by +1, by using the aforementioned data ID as a key, with respect to all the records corresponding to other data IDs which are the same as the data ID of the objective data. Furthermore, the processor 304 updates a storage address (corresponding to the pool address described later) corresponding to the above-mentioned other data with a storage address (corresponding to the pool address described later) corresponding to the data ID of the objective data in the redundancy management information table 600. More specifically, the following processing is executed.

(1-12) Specific Example of Redundancy Judgment Procedure

The redundancy judgment processing sequence shown in FIG. 13 will be specifically explained below.

(1-12-1) First Redundancy Judgment Procedure

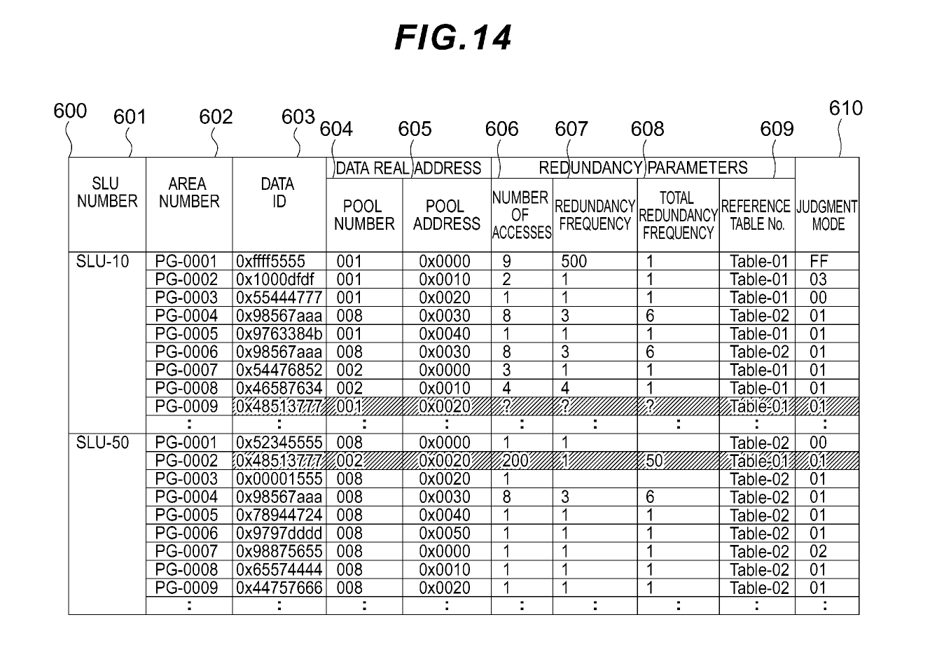

FIG. 14 shows a specific example of a first redundancy judgment procedure. The data ID 603 of the objective data is 0x48513777 when the SLU number 601 is SLU-10 and the area number 602 is PG-0009. The judgment mode 610 for this data ID entry is 01. If the judgment mode 610 is 01, whether the Redundancy Elimination should be performed or not is judged using the number of accesses 606 and the total redundancy frequency 607 during the redundancy judgment processing. Regarding the data ID entry that is identical to the above-mentioned data ID 603, the SLU number 601 is SLU-50 and the area number is PG-0002. As judgment thresholds for the first redundancy judgment procedure, for example, the number of accesses 606 is 10 or more per 30 days and the total redundancy frequency is 50 or more. If the aforementioned SLU number 601 is SLU-50 and the area number 602 is PG-0002, both the number of accesses 606 and the total redundancy frequency 607 are more than the respective thresholds and, therefore, the Redundancy Elimination is regulated.

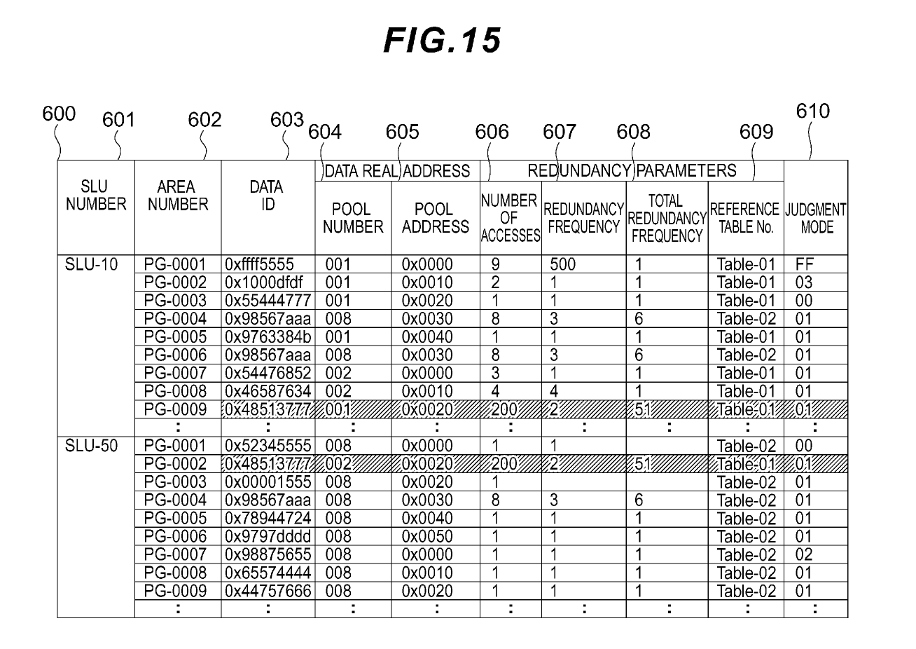

Specifically speaking, the entry whose SLU number 601 is SLU-10 and area number 602 is PG-0009 is updated so that the number of accesses 606 is set to 200, the redundancy frequency 607 is set to 2, and the total redundancy frequency 608 is set to 51 as shown in FIG. 15. As a result, these two entries show that the same data is written to the same position.

(1-12-2) Second Redundancy Judgment Procedure

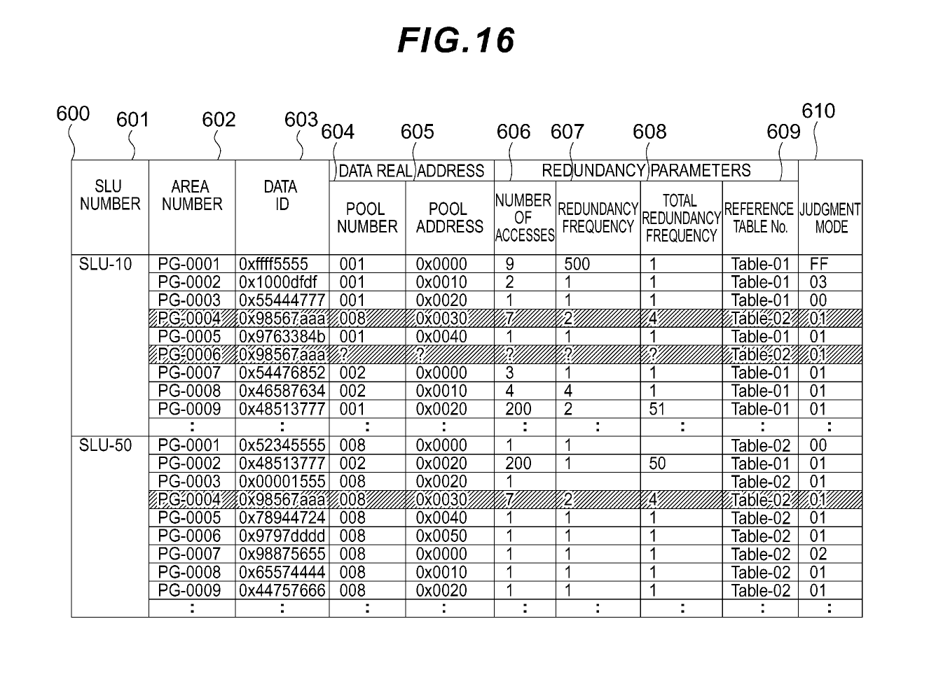

FIG. 16 shows an example of a second redundancy judgment procedure. The data ID 603 of the objective data is 0x98567aaa when the SLU number 601 is SLU-10 and the area number 602 is PG-0006. The judgment mode 610 for this data ID entry is 01. If the judgment mode 610 is 01, whether the Redundancy Elimination should be performed or not is judged using the number of accesses 606 and the total redundancy frequency 607 during the redundancy judgment processing. Two data ID entries which are identical to the above-described data ID 603 exist. Regarding the first entry, the SLU number 601 is SLU-10 and the area number is PG-0006. Regarding the second entry, the SLU number 601 is SLU-50 and the area number is PG-0004. As judgment thresholds for the second redundancy judgment procedure, for example, the number of accesses 606 is 10 or more per 30 days and the total redundancy frequency is 50 or more. If the aforementioned SLU number 601 is SLU-10 and the area number 602 is PG-0006, both the number of accesses 606 and the total redundancy frequency 607 are more than the respective thresholds and, therefore, the Redundancy Elimination is regulated.

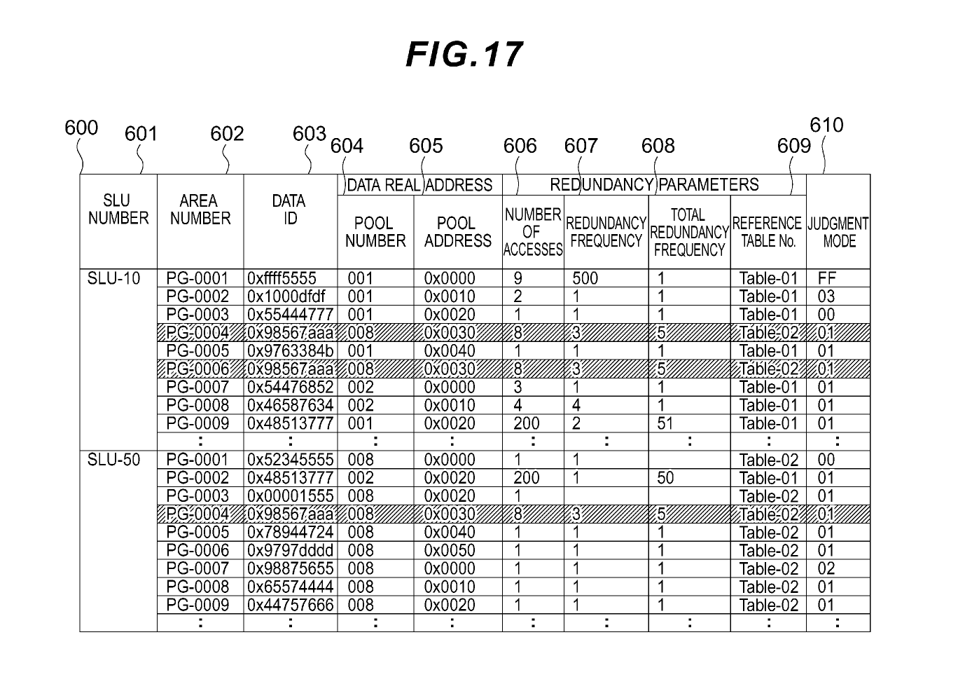

Specifically speaking, the first entry whose SLU number 601 is SLU-10 and area number 602 is PG-0006 is updated so that the number of accesses 606 is set to 8, the redundancy frequency 607 is set to 3, and the total redundancy frequency 608 is set to 5 as shown in FIG. 17. On the other hand, the second entry whose SLU number 601 is SLU-50 and area number 602 is PG-0004 is updated so that the number of accesses 606 is set to 8, the redundancy frequency 607 is set to 3, and the total redundancy frequency 608 is set to 5. As a result, these three entries show that the same data is written to the same position.

(1-13) Redundancy Elimination Inhibition

The first embodiment is designed to not just execute the Redundancy Elimination processing, but inhibit this Redundancy Elimination processing in accordance with the following policies. An example of variations of how to keep the duplicate data will be explained below.

(1-13-1) First Policy

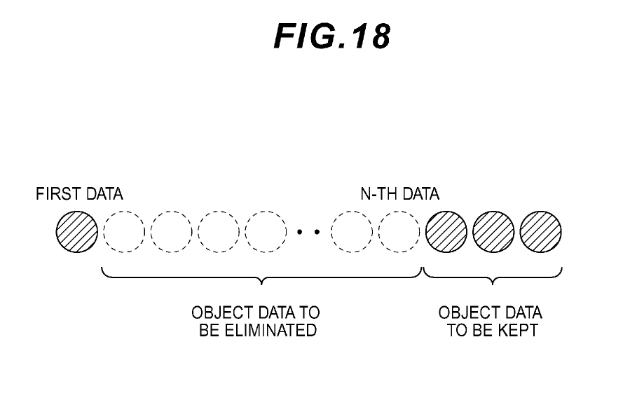

FIG. 18 shows a method of applying a first policy for inhibiting the Redundancy Elimination processing. After receiving data via the host interface control unit 301, the processor 304 executes processing to keep the duplicate data in accordance with the following first policy. Specifically speaking, after the processor 304 keeps, for example, the first data, it eliminates writing of the second to N-th data. Furthermore, the processor 304 keeps the N+1-th data and any subsequent data.

The processor 304 adopts the following method as a method for deciding the N-th data. This is the case where the Redundancy Elimination is performed on the source (the storage apparatus 201 for primary data) side in the first embodiment. If the processor 304 recognizes that the same data already exists, the storage apparatus 201 controls to not store that duplicate data. As the first judgment rule, the processor 304 decides the N-th data based on the access frequency (for example, the number of times the first data is read). Also, the processor 304 may decide the N-th data by referring to performance such as IOPS (I/O per second); for example, if the IOPS has decreased, the processor 304 judges that the performance has degraded, and may decide the N-th data so as to regulate the Redundancy Elimination.

(1-13-2) Second Policy

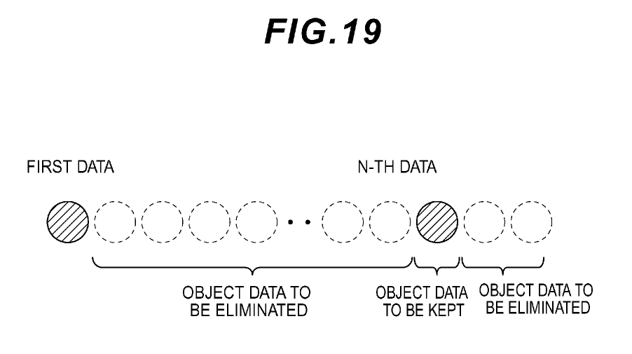

FIG. 19 shows a method of applying a second policy for inhibiting the Redundancy Elimination processing. The processor 304 keeps every N-th data. For example, the processor 304 controls the Redundancy Elimination to keep, for example, two pieces of data in a case of 2N or three pieces of data in a case of 3N. As another method, the processor 304 continues eliminating redundancy from the N+1-th data. For example, the processor 304 secures N pieces of data in a case of N+1 or N pieces of data in a case of N+2. Incidentally, if the number of data reaches a certain constant, the processor 304 may control the redundant elimination to not keep any further data. Subsequently, if the number of accesses decreases, the processor 304 reduces the number of N pieces of data by half. If the number of accesses further decreases, the processor 304 deletes the remaining data.

(1-13-4) Example of Redundancy Judgment Processing

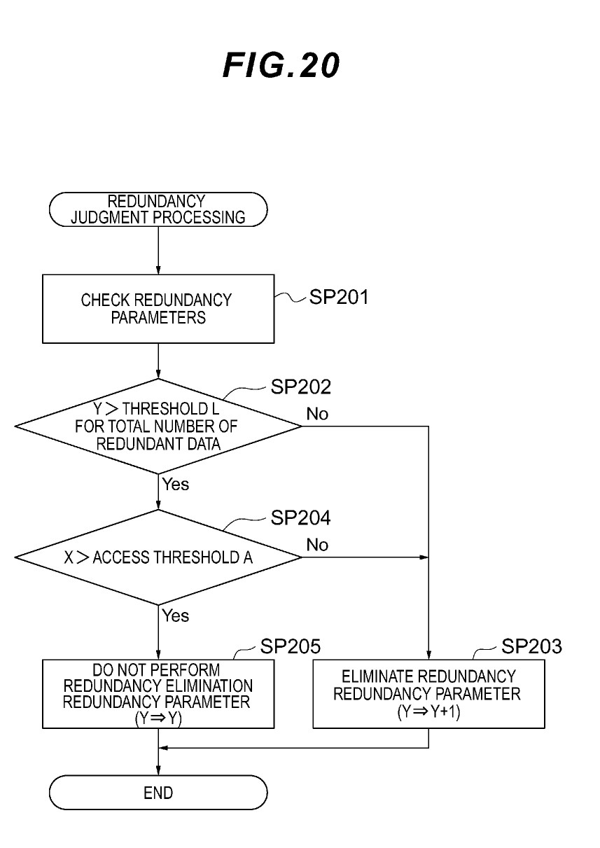

FIG. 20 shows a first example of the redundancy judgment processing. The first example focuses on how to keep data. The processor 304 keeps data on the basis of thresholds for the number of accesses and the total number of duplicate data as examples of the redundancy parameters. Incidentally, in the following explanation, for example, threshold A for the number of accesses is 10 times, threshold L for the total number of duplicate data is 50, the number of permitted duplicate data N is 3 (the Redundancy Elimination is performed on the N+1-th data and any subsequent data), and the number of intermittent permitted duplicate data M is 10 (duplication stop every M+1-th data).

The processor 304 checks the aforementioned redundancy parameters (SP201). The redundancy parameters herein used are, for example, the number of accesses X and the total number of duplicate data Y. The processor 304 checks if the total number of duplicate data Y is larger than the threshold L for the total number of duplicate data or not (SP202). If the total number of duplicate data Y is not larger than the threshold L for the total number of duplicate data, the processor 304 performs the Redundancy Elimination and deletes the data (SP203) and adds +1 to the total number of duplicate data Y. On the other hand, if the total number of duplicate data Y is larger than the threshold L for the total number of duplicate data, the processor 304 does not perform the Redundancy Elimination and keeps the data (SP205), and does not increase the total number of duplicate data Y.

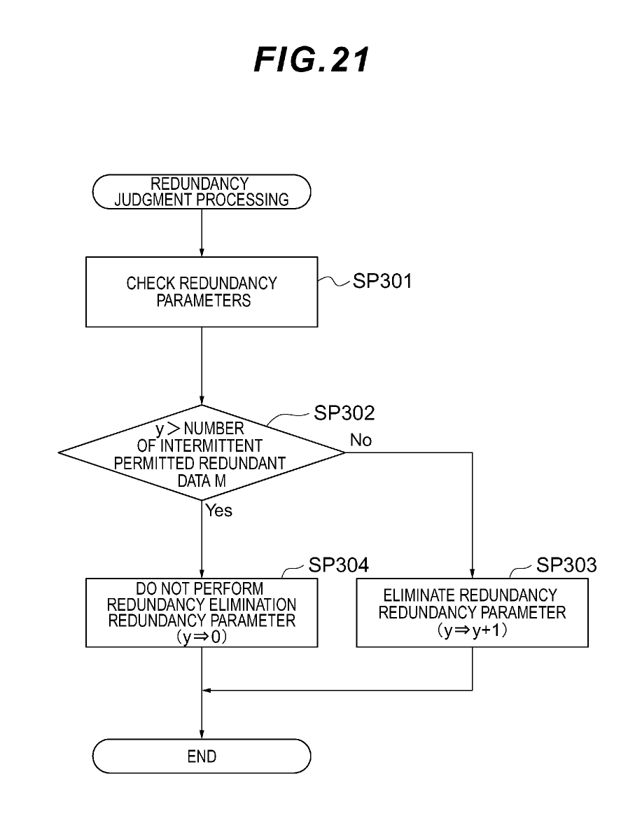

FIG. 21 shows a second example of the redundancy judgment processing. In the second example, how to keep data is inhibited in order to keep every M-th data on the basis of thresholds for the number of accesses and the total number of duplicate data as examples of the redundancy parameters. It should be noted that the third and subsequent examples, unlike the first example, also focus on inhibition of how to delete data.

The processor 304 checks the redundancy parameters (SP301). The redundancy parameters herein used are, for example, the number of accesses X and the redundancy frequency y. The processor 304 checks if the redundancy frequency y is larger than the number of intermittent permitted duplicate data M (SP302). If the redundancy frequency y is not larger than the number of intermittent permitted duplicate data M, the processor 304 eliminates redundancy (SP303) and adds +1 to the redundancy frequency y. On the other hand, if the redundancy frequency y is larger than the number of intermittent permitted duplicate data M, the processor 304 does not perform the Redundancy Elimination (SP304) and changes the redundancy frequency y to 0.

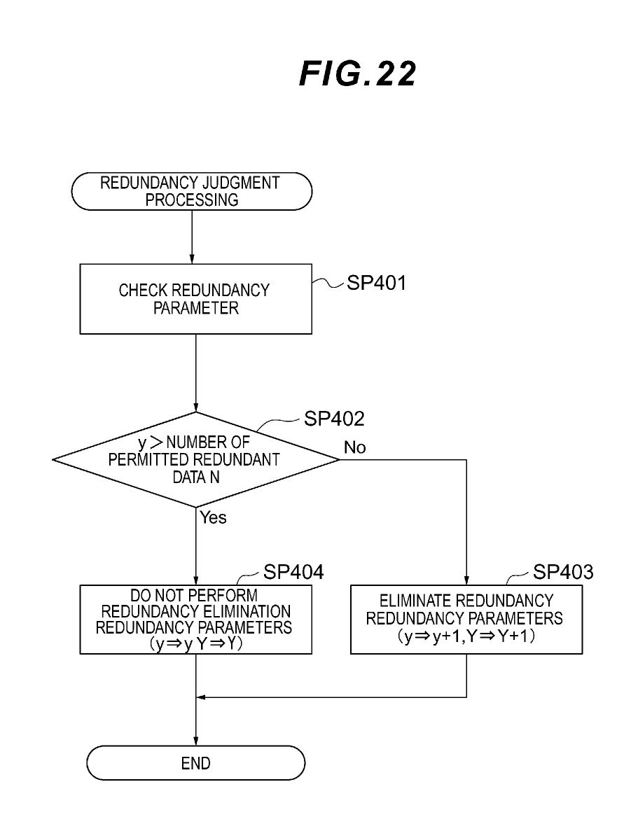

FIG. 22 shows a third example of the redundancy judgment processing. In the third example, the processor 304 continues eliminating redundancy in the N+1-th data and any subsequent data on the basis of a threshold for the redundancy frequency y as an example of the redundancy parameter. For example, the processor 304 secures N pieces of data in a case of N+1 or N pieces of data in a case of N+2.

The processor 304 checks the redundancy parameter (SP401). The redundancy parameter herein used is, for example, the redundancy frequency y. The processor 304 checks if the redundancy frequency y is larger than the number of permitted duplicate data N or not (SP402). If the redundancy frequency y is not larger than the number of permitted duplicate data M, the processor 304 eliminates redundancy (SP403), adds +1 to the redundancy frequency y, and also adds +1 to the total number of duplicate data Y. On the other hand, if the redundancy frequency y is larger than the number of permitted duplicate data N, the processor 304 does not perform the Redundancy Elimination (SP404), sets the redundancy frequency y to y, and adds +1 to the total number of duplicate data Y.

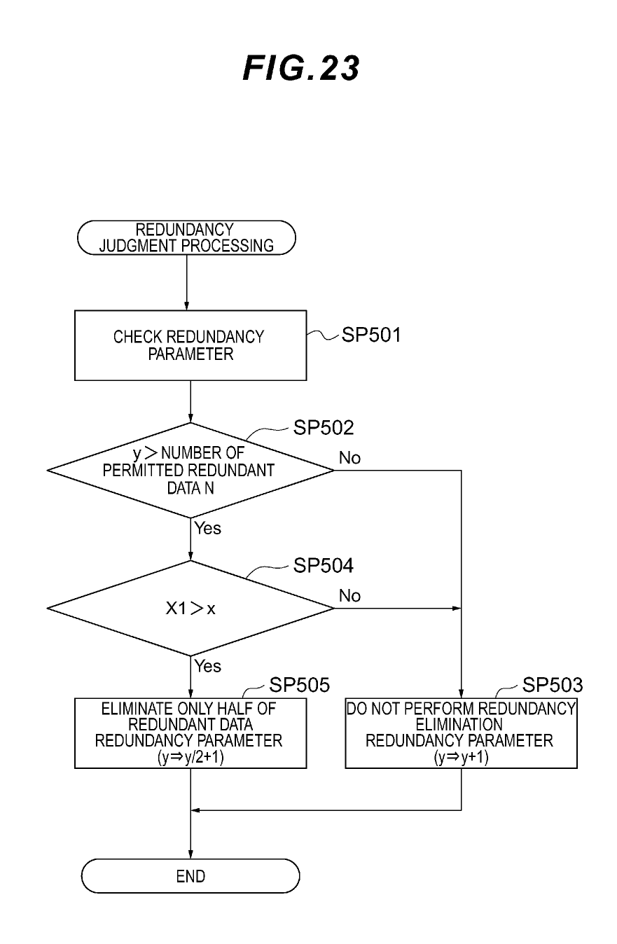

FIG. 23 shows a fourth example of the redundancy judgment processing. In the fourth example, the number of N pieces of data is reduced by half when the number of accesses to the data has decreased (as compared with the number of accesses T hours ago). At present, the number of accesses is X1 and the redundancy frequency is y. The number of accesses T hours ago is x.

The processor 304 checks the redundancy parameter (SP501). The redundancy parameter herein used is, for example, the redundancy frequency y. The processor 304 checks if the redundancy frequency y is larger than the number of permitted duplicate data N or not (SP502). If the redundancy frequency y is not larger than the number of permitted duplicate data M, the processor 304 does not perform the Redundancy Elimination (SP503) and adds +1 to the redundancy frequency y. On the other hand, if the redundancy frequency y is larger than the number of permitted duplicate data N, the processor 304 checks if the number of accesses X1 is larger than x or not (SP504). If the number of accesses X1 is not larger than x, the processor 304 executes the aforementioned step SP503. On the other hand, if the number of accesses X1 is larger than x, the processor 304 eliminates only half of the duplicate data (SP505) and sets the redundancy frequency y to (y/2+1).

(1-14) Advantageous Effects of First Embodiment

If a write request is issued from any of the file servers 100 corresponding to a plurality of host systems to write duplicate data as objective data which is identical to already stored data, the processor 304 controls the data transfer control unit 302 to keep part of the duplicate data in accordance with the specific rule instead of eliminating writing of all the duplicate data in the present embodiment as described above. As a result, it is possible to inhibit degradation of the read performance and reduce the data capacity.

In the present embodiment, the data transfer control unit 302 includes: the data control unit 308 for transferring the objective data from each of the plurality of host systems 100, 101 to the disk unit 307 and transferring data stored in the disk unit 307 to each of the plurality of host systems 100, 101; the data placement management unit 309 for managing the placement of the objective data, the stored data, and the duplicate data; and the redundancy analyzer 310 for analyzing whether the objective data of a write request is stored data or not if the write request is issued from any the plurality of host systems 100, 101.

In the present embodiment, the processor 304 controls inhibition of the write amount of the duplicate data in accordance with the specific rule.

In the present embodiment, the processor 304 uses the redundancy parameters as the specific rule which is the basis of judgment of whether the aforementioned Redundancy Elimination should be performed or not. Consequently, if the redundancy parameters of various contents are prepared, it is possible to make the Redundancy Elimination judgment of various contents.

In the present embodiment, the processor 304 uses, as the redundancy parameters, a combination of any of the number of accesses to the duplicate data, the redundancy frequency and the total redundancy frequency.

In the present embodiment, the disk controller 210 is equipped with the metadata memory 305, and this metadata memory 305 stores at least the redundancy management information table 600. This redundancy management information table 600 manages the cache memory 306 for temporarily storing the objective data and the duplicate data, and the content of the redundancy parameters about the objective data, the stored data, and the duplicate data.

In the present embodiment, the redundancy management information table 600 manages, separately from the redundancy parameters, the judgment mode as a method for judging whether the Redundancy Elimination should be performed or not. As a result, it is possible to adopt various judgment methods for the Redundancy Elimination judgment.

In the present embodiment, If a write request is issued, the processor 304 searches the redundancy management information table 600 by using the data ID, as a key, of the objective data corresponding to the write request; and if another data corresponding to that data ID exists, the processor 304 updates the redundancy parameter(s) about that other data.

### (2) Second Embodiment

Since the configuration of a storage system in the second embodiment is almost the same as that of the storage system 1 according in the first embodiment, the same reference numerals are given to the same components and an explanation of such components has been omitted. The following explanation will focus on the difference between the first embodiment and the second embodiment. The difference between a storage apparatus in the second embodiment and the storage apparatus 201 for primary data in the first embodiment is that the storage apparatus in the second embodiment is a backup storage apparatus.

Specifically speaking, in the second embodiment, the backup storage apparatus receives differential data from the storage apparatus 201 for the primary data in the first embodiment and executes a backup using that differential data on backed-up data. Therefore, the backup storage apparatus in the second embodiment is based on the premise that the already backed-up data originally exists. In addition to that, the situation where the differential data is written to that backed-up data is assumed in the second embodiment; and when writing the differential data, whether the Redundancy Elimination should be regulated or not is control as in the first embodiment.

(2-1) Concept

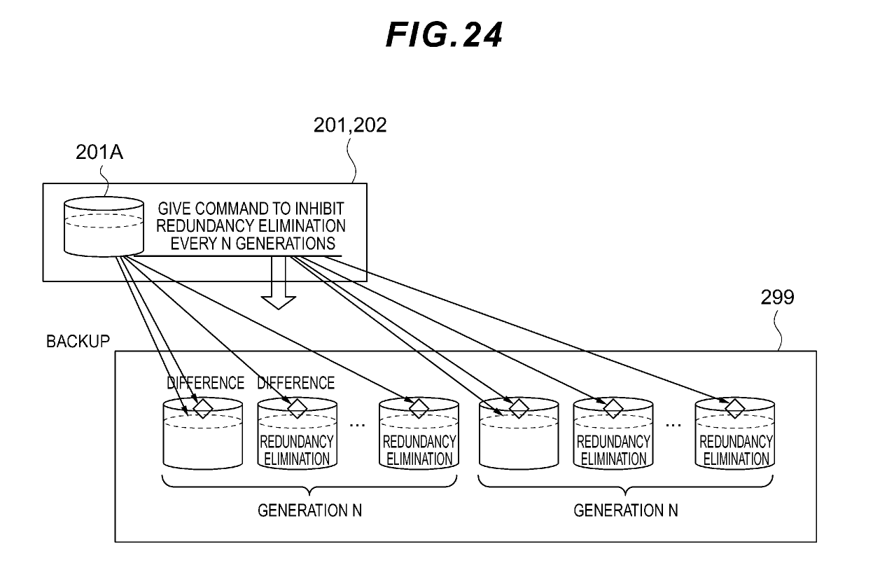

FIG. 24 shows an example of the concept in the second embodiment. When the storage apparatus for backup data receives each piece of differential data from the storage apparatus for the primary data in the second embodiment, the Redundancy Elimination of the differential data is performed in order to avoid redundant storage of the same differential data, while the Redundancy Elimination of the differential data is inhibited in accordance with a specified condition. Specifically speaking, the storage apparatus for the primary data gives a command to inhibit the Redundancy Elimination every N generations, while the storage apparatus 201 inhibits the Redundancy Elimination of the differential data every N generations. As a result, it is possible to reduce the risk of having a failure in the duplicate data affect the entire backup data.

(2-2) Configuration of Storage System

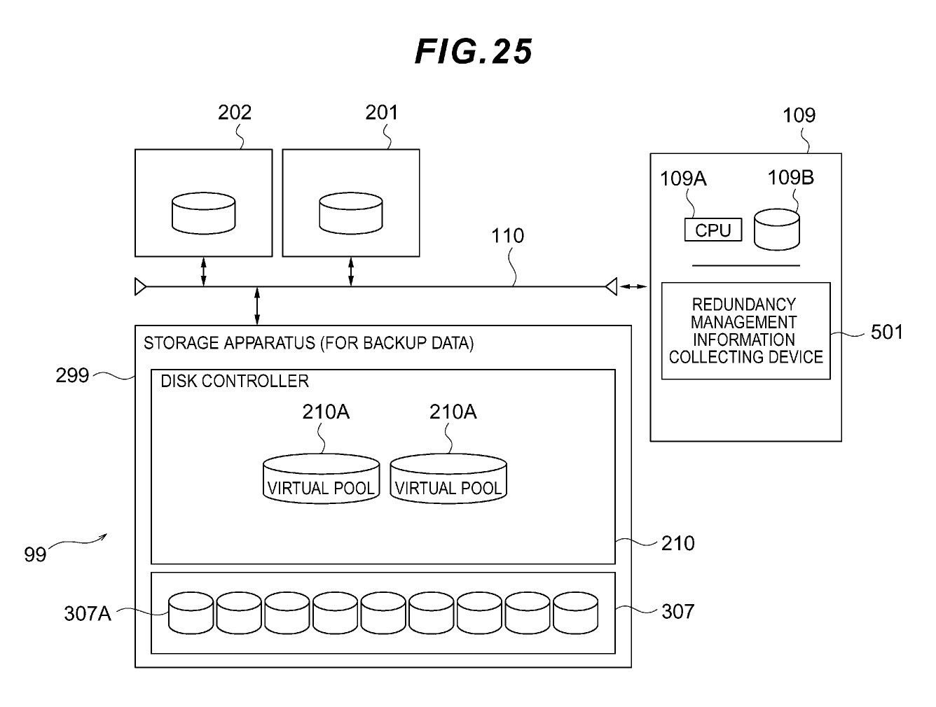

FIG. 25 shows the schematic configuration of a storage system 99 in the second embodiment. Since this storage system 99 has almost the same configuration as that of the storage system 1 in the first embodiment as mentioned above, the following explanation will focus on the difference between them.

The storage system 99 in the second embodiment is configured so that storage apparatuses 201, 202 for primary data having almost the same configuration as that of the storage apparatus in the first embodiment, instead of the file servers 100, 101 existing in the storage system 1 in the first embodiment, are connected to a network 110. The number of such storage apparatuses 201, 202 is not limited to two, and three or more storage apparatuses may be provided.

Furthermore, while the management server 109 is required in the first embodiment when a plurality of file servers 100, 101 are provided, the management server 109 is indispensable in the second embodiment. Specifically speaking, the configuration and functions of the disk controller 210 for the storage apparatus 201 and the management server 109 in the second embodiment are different from those in the first embodiment.

A storage apparatus 299 manages a data placement map, a data redundancy counter, and data access frequency information. The data placement map, data redundancy counter 221, and data access frequency information in the second embodiment are almost the same as those in the first embodiment, but there is the following difference between them. Specifically speaking, the data redundancy counter includes device redundancy and the data access frequency information includes inter-storage-apparatus total data access frequency information.

The management server 109 includes the redundancy management information collecting device 501 as in the first embodiment, and this redundancy management information collecting device 501 collects redundancy management information from each of the storage apparatuses 201, 202 and 299.

(2-3) Redundancy Elimination Inhibition

(2-3-1) First Policy

After receiving differential data from the storage apparatus 201 for primary data via the host interface control unit 301 in the state where backed-up data exists, the processor 304 controls the Redundancy Elimination of the differential data as described below. Specifically speaking, the processor 304 executes the Redundancy Elimination to keep the N-th differential data as a method of keeping the duplicate data in accordance with the first policy as shown in FIG. 18 in the same manner as in the first embodiment. Specifically speaking, after the processor 304 keeps, for example, the first data, it eliminates writing of the second to the N-th data. Furthermore, the processor 304 keeps the N+1-th and any subsequent data.

The processor 304 adopts the following method as a method for deciding the N-th data. This is the case in the second embodiment where the Redundancy Elimination is performed on the backup storage (the backup storage apparatus 299) side. If the processor 304 counts the redundancy frequency of the differential data, the storage apparatus 299 controls the data control unit 308 to keep the differential data whose redundancy frequency is high, without deleting the differential data to a certain degree (corresponding to the procedure illustrated in the flowchart described earlier with reference to FIG. 20).

Furthermore, as another method for deciding the N-th data, the processor 304 uses information about the redundancy frequency and the access frequency, which was obtained during the Redundancy Elimination on the source (the storage apparatus 201 for the primary data) side, for the Redundancy Elimination in the backup storage apparatus 299. Specifically speaking, the processor 304 may count the redundancy frequency on the source side and then control the Redundancy Elimination to keep the differential data whose redundancy frequency is high, thereby determining the N-the data.

(2-3-2) Second Policy

In the second embodiment, the processor 304 of the backup storage apparatus 299 may control the Redundancy Elimination with respect to writing of the differential data, instead of data, according to a policy similar to the second policy in the first embodiment.

Incidentally, the second embodiment is almost the same as the first embodiment, except that the Redundancy Elimination is controlled with respect to writing of the differential data instead of the data.

(2-4) Advantageous Effects of Second Embodiment

If a write request is issued for the backup purpose from the plurality of host systems (for example, the storage apparatuses 201, 202 for the primary data) to write duplicate data as object differential data which is identical to differential data corresponding to the stored data as described above, the processor 304 controls the data control unit 308 in the second embodiment to keep part of the duplicate data in accordance with the specified policy instead of eliminating all the duplicate data. As a result, even if a failure occurs in the duplicate data, it is possible to reduce the risk of having the failure affect the entire backup data.

Furthermore, in the second embodiment, the processor 304 controls the data control unit 308 to keep part of the duplicate data for each generation of the backup as described above. As a result, it is possible to reduce the risk of having a failure in the duplicate data affect the entire backup data.

### (3) Application to Backup Restoration

In addition to the aforementioned concept, the concept of this application is based on an idea that if the redundancy can be used redundantly when a failure occurs, and if the same data ID as that of objective data where the failure has occurred exists in the redundancy management information table 600, substitute data corresponding to the same data ID can be used to substitute the original objective data. Specifically speaking, the present embodiment described above focuses on hot to keep a certain amount of data, and the objective data is substituted with such substitute data as a new means of using the thus kept data.

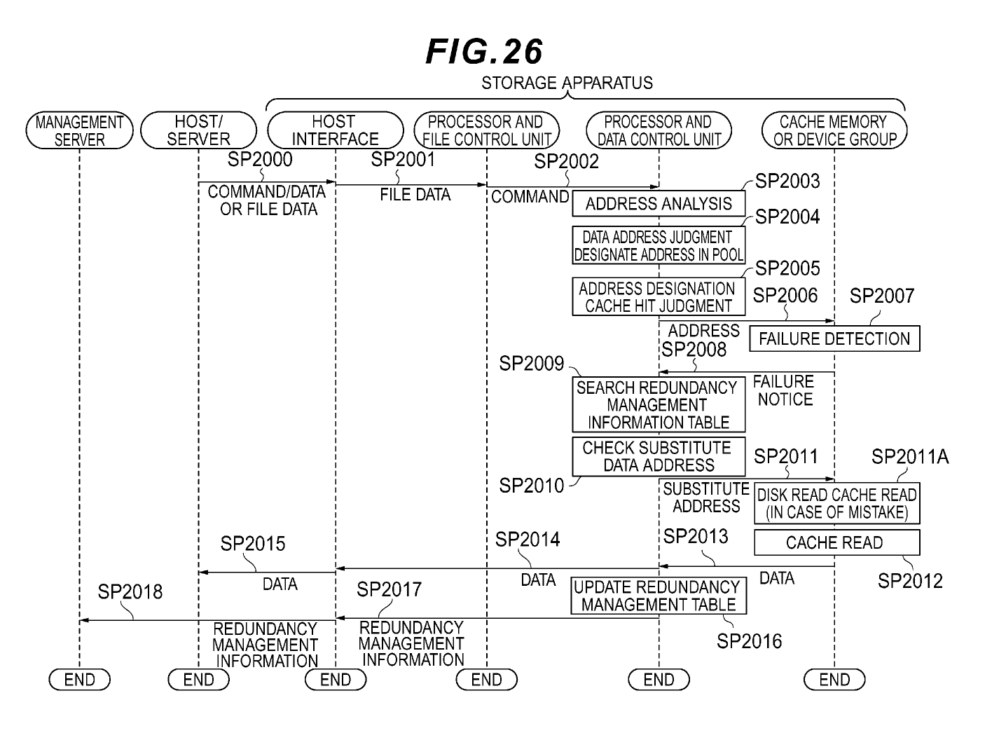

FIG. 26 shows an application to backup restoration. Incidentally, a host/server in the drawing indicates the file server 100, a host interface in the drawing indicates the aforementioned host interface control unit 301, and a device group in the drawing indicates a storage device group in the disk unit 307. The illustrated example in FIG. 26 shows the passage of time as it goes downwards in a vertical direction.

For example, the file server 100 sends a command/data in a case of the block control method or file data in a case of the file control method to the host interface control unit 301 mounted in the disk controller 210 for the storage apparatus 201 via the network 110 (SP2000).

In the case of the file control method, the host interface control unit 301 delivers the file data to the processor 304 and the file control unit 320 (SP2001). The file control unit 320 delivers the command to the data control unit 308 (SP2002).

The processor 304 performs address analysis to interpret the address of the delivered objective data (SP2003). The data control unit 308 performs the data address judgment and designates an address in a virtual pool (SP2004). The data control unit 308 designates the address and performs cache hit judgment (SP2005). The data control unit 308 notifies the cache memory 306 and others of the address (SP2006). The cache memory 306 and others detect a failure (SP2007). The data control unit 308 is notified of the occurrence of the failure (SP2008).

The data control unit 308 searches the redundancy management information table 600 to find out whether the data ID corresponding to the data ID of, for example, the objective data destroyed by the failure exists or not (SP2009). If such data ID exists in the redundancy management information table 600, the data control unit 308 checks the address of substitute data corresponding to that data ID (SP2010). The data control unit 308 notifies the cache memory 306 and others of the address of the substitute data (the substitute address in the drawing) (SP2011).

The cache memory 306 and others execute disk read on the basis of the address of the substitute data (SP2011A). Next, the cache memory 306 and others execute cache read on the substitute data (SP2012).

The data control unit 308 receives the substitute data from the cache memory 306 and others (SP2013). The data control unit 308 delivers the substitute data to the host interface control unit 301 and updates the redundancy management information table 600 (SP2014). The host interface control unit 301 sends the substitute data to the file server 100 as a host (SP2015). In this way, the backup storage apparatus 299 has, for example, the file server 100 (or the storage apparatus 201 for the primary data) read the substitute data for the objective data where the failure has occurred.

The data transfer control unit 302 delivers the redundancy management information to the host interface control unit 301 (SP2017). The host interface control unit 301 delivers this redundancy management information to the management server 109 (SP2018).

If the objective data that cannot be used exists and the duplicate data (substitute data) corresponding to this objective data remains, the processor 304 in this application controls the data control unit 308 to substitute the duplicate data with the substitute data. As a result, the data which can no longer be used can be restored by using another data corresponding to the same data ID with that of the data in which the failure has occurred, thereby enhancing reliability.

### (4) Example of Cooperation with Backup Software

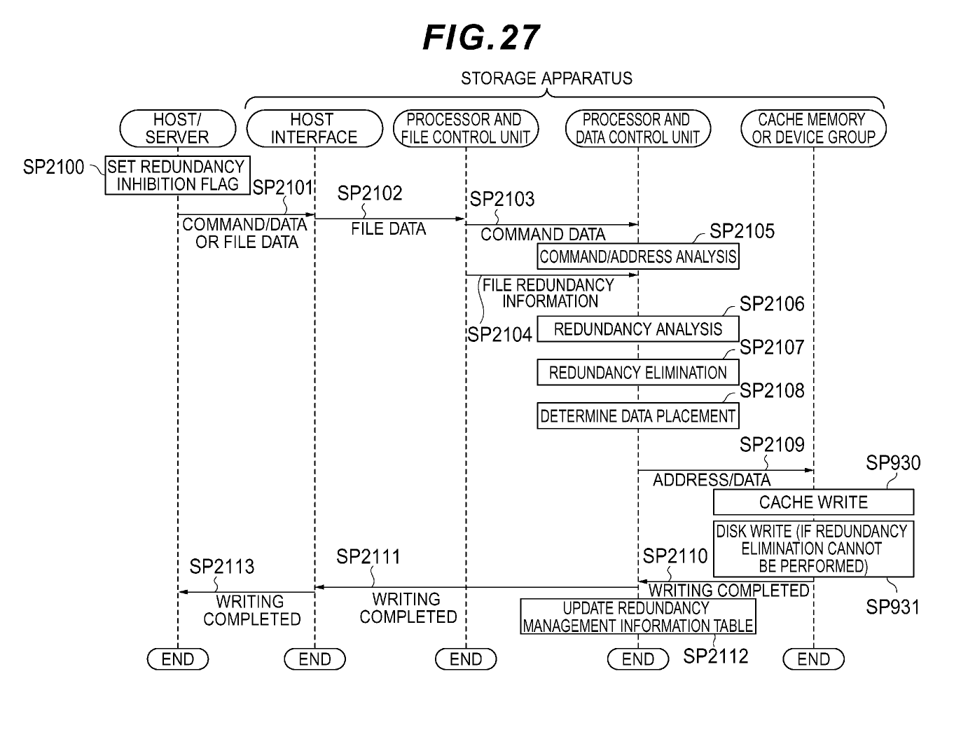

FIG. 27 shows an example of cooperation with backup software. Incidentally, a host/server in the drawing indicates the file server 100, a host interface in the drawing indicates the aforementioned host interface control unit 301, and a device group in the drawing indicates a storage device group in the disk unit 307. The illustrated example in FIG. 27 shows the passage of time as it goes downwards in a vertical direction.

The file server 100 as a host embeds a redundancy elimination inhibition flag as a command or in a file (SP2100). This redundancy elimination inhibition flag corresponds to information indicating that part of the duplicate data should be kept; and it is included in a write request. For example, the file server 100 sends a command/data in a case of the block control method or file data in a case of the file control method to the host interface control unit 301 mounted in the disk controller 210 for the storage apparatus 201 via the network 110 (SP2101).

In the case of the file control method, the host interface control unit 301 delivers the file data to the processor 304 and the file control unit 320 (SP2102). The file control unit 320 changes the file data to a command/data and delivers the command/data to the data control unit 308 for the data transfer control unit 302 (SP2103). The processor 304 performs address analysis to interpret the address of the delivered objective data (SP2105). Then, the data control unit 308 obtains file redundancy information from the file control unit 320 (SP2104).

Next, the processor 304 performs redundancy analysis (SP2106). In this redundancy analysis, the processor 304 judges whether or not the data ID corresponding to the objective data exists in the redundancy management information table 600. If the corresponding data ID does not exist, the processor 304 collates the SLU number corresponding to that data ID and analyzes the number of accesses and the redundancy relating to that data.

Next, the processor 304 inhibits the Redundancy Elimination unconditionally based on the redundancy elimination inhibition flag (SP2107). The processor 304 decides the data placement (SP2108). Subsequently, the processor 304 controls the data control unit 308 and delivers the data and its address to the cache memory 306 and the device group (SP2109). The cache memory 306 and others execute cache write (SP930) and the data control unit 308 receives notice of completion of writing (hereinafter referred to as the write completion notice) from the cache memory 306 and others (SP909). If the Redundancy Elimination cannot be performed (in a case where the judgment mode is 00), the processor 304 has the data control unit 308 control the device I/F control unit 303 and executes writing (disk write) to the volume 307A in the disk unit 307 (SP931).

After receiving the write completion notice, the data control unit 308 sends the write completion notice to the host interface control unit 301 (SP2111). The host interface control unit 301 sends the write completion notice to the file server 100 (SP2113).

Meanwhile, after the data control unit 308 sends the write completion notice to the host interface control unit 301 as described above, the processor 304 updates the redundancy management information table 600, using the data ID as a key (SP2112).

In this application, the processor 304 inhibits the Redundancy Elimination unconditionally in response to the data write request including information indicating that the Redundancy Elimination should be inhibited (redundancy elimination inhibition flag), from the file server 100 which is an example of the host system. As a result, the reliability of the duplicate data can be enhanced in response to a request from the host system.

### (5) Another Embodiment

Since a storage system in another embodiment has almost the same configuration as that of the storage systems 1, 99 in the first and second embodiments, the same reference numerals are given to the same components and an explanation of such components has been omitted. The following explanation will focus on the difference between the first and second embodiments and that other embodiment.

(5-1) Concept

The other embodiment is configured so that on the premise of a technique for managing virtual pools by combining so-called Thin Provisioning and dynamic hierarchical control, data is automatically sorted to a specified storage device (such as SATA) from among different types of storage devices such as so-called SSD (Solid State Drives), SAS (Serial Attached SCSI), or SATA (Serial Advanced Technology Attachment); and the other embodiment is designed to perform the Redundancy Elimination only on data stored in storage areas in the specified storage device in accordance with a policy described below.

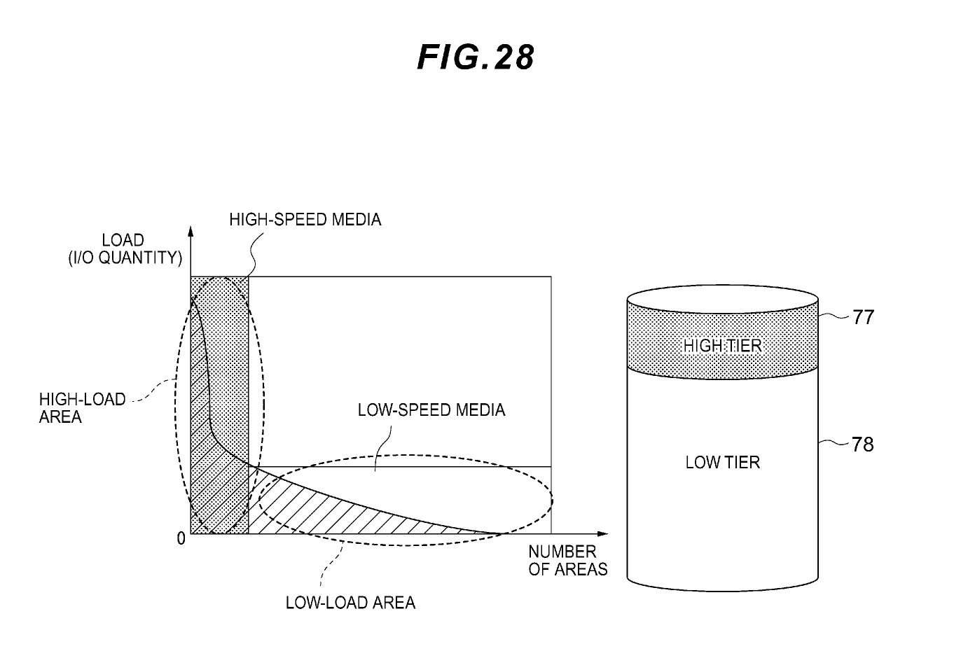

FIG. 28 shows an example of load on the number of areas when high-speed media and low-speed media are used in the case where the concept of the aforementioned dynamic hierarchical control is adopted. The stored data are often distributed in a High Tier 77 and a Low Tier 78 according to the access frequency from the host (host system). The High Tier 77 has high access frequency, but a small capacity. On the other hand, the Low Tier 78 has low access frequency, but a large capacity. If high-performance device groups such as SSD or SAS are used for the High Tier 77 and low-speed, large-capacity, and inexpensive device groups such as SATA are used for the Low Tier 78, cost optimization can be achieved.

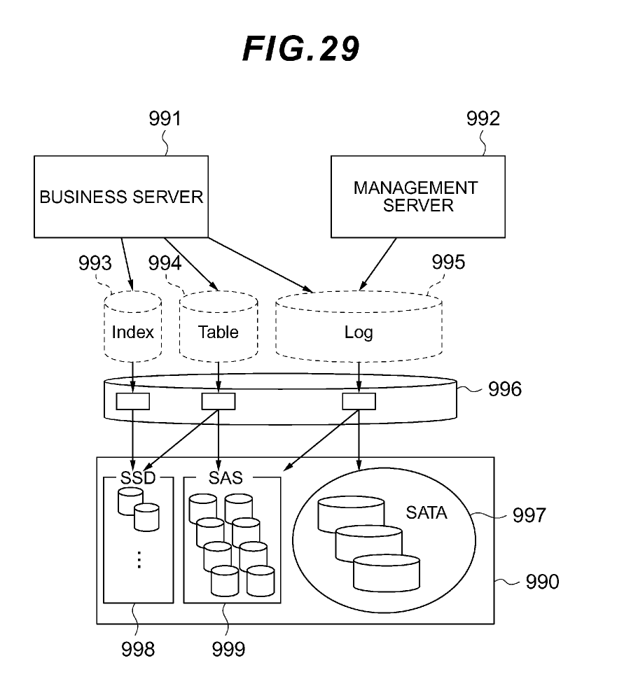

FIG. 29 shows a configuration example for a storage system that adopts the aforementioned dynamic hierarchical control. A business server 991 writes data to an index 993, table 994, and log 995 which are virtual volumes. This data is stored in a virtual pool 996. If the access frequency of certain data decreases, the processor 304 automatically migrates the data from the High Tier 77 to the Low Tier 78 by means of the aforementioned dynamic hierarchical control.

The following policy is set for the operation by the above-described configuration. Specifically speaking, the processor 304 executes the Redundancy Elimination judgment in accordance with the following third policy depending on the area, location, and property of certain data.

(A) The object of the Redundancy Elimination is data collected in the Low Tier 78.

(B) The Low Tier 78 where the data is collected may be specially distinguished as Redundancy Elimination Tier from other Low Tiers 78.

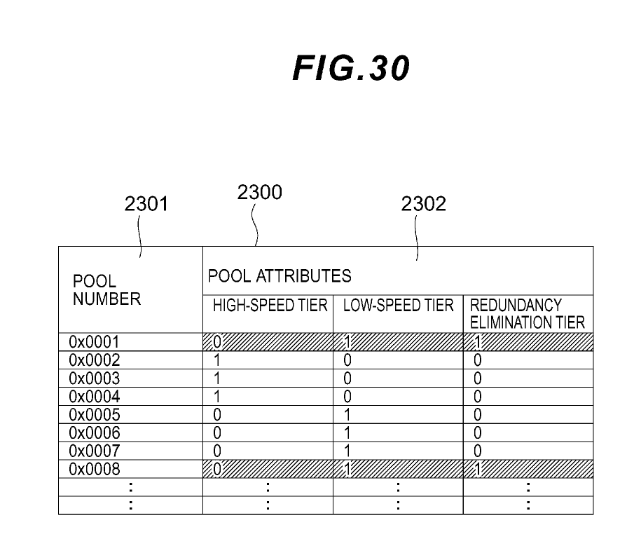

FIG. 30 shows an example of a pool attribute table 2300 showing the correspondence relationship between pool attributes for each pool number 2301. The pool number 2301 herein used corresponds to the pool number 604 in FIG. 7. The pool attributes 2302 include the High-speed Tier 77, the Low-speed Tier 78, and the Redundancy Elimination Tier. FIG. 30 shows that the relevant pool attribute 2302 is ON when 1 is stored; and the relevant pool attribute is OFF when 0 is stored. In the example shown in the drawing, the pool attribute whose pool number 2301 is 0x0001, and the pool attribute whose pool number 2301 is 0x0008 correspond to object virtual pools for which the Redundancy Elimination should be performed.

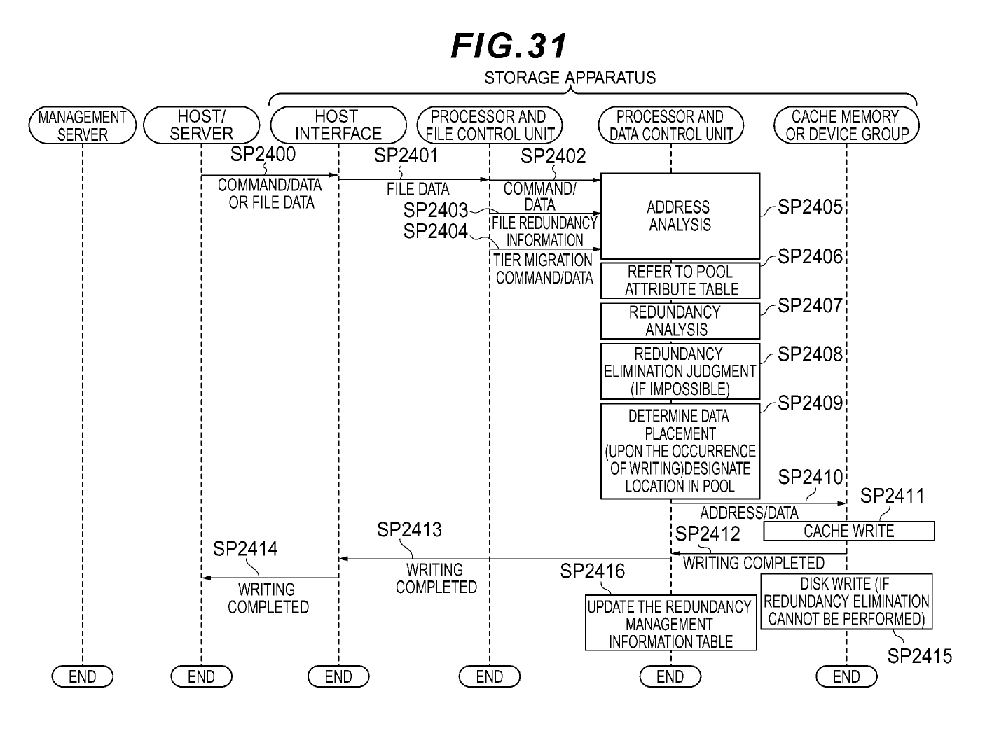

FIG. 31 shows an example of a data writing method corporatively using Dynamic Control and Redundancy Elimination. Incidentally, a host/server in the drawing indicates the file server 100, a host interface in the drawing indicates the aforementioned host interface control unit 301, and a device group in the drawing indicates a storage device group in the disk unit 307. The illustrated example in FIG. 31 shows the passage of time as it goes downwards in a vertical direction.

For example, the file server 100 sends a command/data in a case of the block control method or file data in a case of the file control method to the host interface control unit 301 mounted in the disk controller 210 for the storage apparatus 201 via the network 110 (SP2400).

In the case of the file control method, the host interface control unit 301 delivers the file data to the processor 304 and the file control unit 320 (SP2401). The file control unit 320 changes the file data to a command/data and delivers the command/data to the data control unit 308 for the data transfer control unit 302 (SP2402). On the other hand, in the case of the block control method, the host interface control unit 301 directly delivers the aforementioned command/data to the data control unit 308 without the intermediary of the file control unit 320 (SP2402).

The processor 304 performs address analysis to interpret the address of the delivered objective data (SP2405). Then, in the case of the file control method, the file control unit 320 has provided file redundancy information to the data control unit 308 in advance (SP2403). Furthermore, the file control unit 320 delivers the command/data to the data control unit 308 based on the aforementioned dynamic hierarchical control for the purpose of tier migration. The data control unit 308 refers to the pool attribute table 2300 and determines the object storage device for which the Redundancy Elimination should be performed (SP2406).

Next, the processor 304 performs redundancy analysis (SP2407). In this redundancy analysis, the processor 304 judges whether or not the data ID corresponding to the objective data exists in the redundancy management information table 600. If the corresponding data ID does not exist, the processor 304 collates the SLU number corresponding to that data ID and analyzes the number of accesses and the redundancy relating to that data.

Next, the processor 304 performs the Redundancy Elimination judgment (SP2408).

The processor 304 decides the data placement (SP2409). Subsequently, the processor 304 controls the data control unit 308 and delivers the data and its address to the cache memory 306 and the device group (SP2410). Then, the processor 304 controls the data control unit 308 to migrate the data, for which the Redundancy Elimination should be performed, to the Redundancy Elimination Tier. The cache memory 306 and others execute cache write (SP2411) and the data control unit 308 receives notice of completion of writing from the cache memory 306 and others (SP2412). If the Redundancy Elimination cannot be performed (in a case where the judgment mode is 00), the processor 304 has the data control unit 308 control the device I/F control unit 303 and executes writing (disk write) to the volume 307A in the disk unit 307 (SP2415).

After receiving the write completion notice, the data control unit 308 sends the write completion notice to the host interface control unit 301 (SP2413). The host interface control unit 301 sends the write completion notice to the file server 100 (SP2414).

Meanwhile, after the data control unit 308 sends the write completion notice to the host interface control unit 301 as described above, the processor 304 updates the redundancy management information table 600 (SP2416).

The other embodiment is configured so that on the premise of the technique for managing virtual pools by combining so-called Thin Provisioning and dynamic hierarchical control, objective data is automatically sorted to a specified storage device whose access speed is low, from among different types of storage devices with different access speeds, in accordance with, for example, the access frequency. The processor 304 performs the Redundancy Elimination only on data stored in storage areas in the specified storage device. As a result, the data whose access frequency is low can be automatically set as the object of the Redundancy Elimination.

### (6) Other Embodiments

The above-described embodiments are examples given for the purpose of describing this invention, and it is not intended to limit the invention only to these embodiments. Accordingly, this invention can be utilized in various ways unless the utilizations depart from the gist of the invention. For example, processing sequences of various programs have been explained sequentially in the embodiments described above; however, the order of the processing sequences is not particularly limited to that described above. Therefore, unless any conflicting processing result is obtained, the order of processing may be rearranged or concurrent operations may be performed.

### REFERENCE SIGNS LIST

1 Storage system
100 File server
101 File server
109 Management server
201 Storage apparatus
202 Storage apparatus
210 Disk controller
299 Storage apparatus
302 Data transfer control unit
304 Processor
307 Disk unit
308 Data control unit
501 Redundancy management information collecting device

1. A storage apparatus comprising:
a disk unit equipped with a plurality of storage devices; and
a disk controller for providing a plurality of host systems with a logical volume composed of storage areas in the plurality of storage devices;
wherein the disk controller includes:
a data transfer control unit for transferring objective data to the disk unit in response to write requests from the plurality of host systems and transferring data stored in the disk unit to each of the plurality of host systems; and
a processor for controlling the data transfer control unit so that if any of the plurality of host systems issues a write request to write duplicate data as objective data which is identical to the stored data, part of the duplicate data will be kept in accordance with a specific rule instead of entirely eliminating writing of all the duplicate data.

2. The storage apparatus according to claim 1, wherein the data transfer control unit includes:
a data control unit for transferring objective data from each of the plurality of host systems to the disk unit and transferring data stored in the disk unit to each of the plurality of host systems;
a data placement management unit for managing the placement of the objective data, the stored data, and the duplicate data; and
a redundancy analyzer for analyzing whether objective data of the write request is the stored data or not if the write request is issued from any of the plurality of host systems.

3. The storage apparatus according to claim 1, wherein the processor controls inhibition of a write amount of the duplicate data in accordance with the specific rule.

4. The storage apparatus according to claim 1, wherein the processor uses, as the specific rule, a redundancy parameter serving as a basis for judging whether the redundancy elimination should be performed or not.

5. The storage apparatus according to claim 1, wherein the processor uses, as the redundancy parameter, a combination of any of the number of accesses, redundancy frequency, and total redundancy frequency of the duplicate data.

6. The storage apparatus according to claim 1, wherein the disk controller includes:
a cache memory for temporarily storing the objective data and the duplicate data; and
a specified memory storing a redundancy management information table for managing the content of the redundancy parameter relating to the objective data, the stored data, and the duplicate data.

7. The storage apparatus according to claim 6, wherein the redundancy management information table manages, other than the redundancy parameter, a judgment mode as a method for judging whether the redundancy elimination should be performed or not.

8. The storage apparatus according to claim 1, wherein if the write request is issued, the processor searches the redundancy management information table by using, as a key, a data ID of the objective data corresponding to the write request; and if another data corresponding to the data ID exists, the processor updates the redundancy parameter relating to the other data.

9. The storage apparatus according to claim 4, wherein the disk controller includes a file control unit for, if data from the host system is in a file format, converting the file-format data and delivering it to the data transfer control unit, while converting data from the data transfer control unit into the file format and delivering it to the host system.

10. The storage apparatus according to claim 1, wherein if any of the plurality of host systems issues a write request to write duplicate data as object differential data, which is identical to differential data corresponding to the stored data, for the purpose of a backup, the processor controls the data control unit to keep part of the duplicate data in accordance with the specific rule instead of eliminating all the duplicate data.

11. The storage apparatus according to claim 10, wherein the processor controls the data control unit to keep part of the duplicate data for each generation of the backup.

12. The storage apparatus according to claim 1, wherein if the objective data which cannot be used exists and the duplicate data corresponding to the objective data remains, the processor controls the data control unit to substitute the objective data with substitute data.

13. The storage apparatus according to claim 1, wherein if the write request includes information indicating that part of the duplicate data should be kept, the processor controls the data control unit to inhibit the redundancy elimination.

14. The storage apparatus according to claim 1, wherein the processor automatically sorts the objective data in accordance with, for example, access frequency and stores it in a specified storage device with a low access speed from among storage devices with different kinds of access speeds and then performs the redundancy elimination on the data stored in storage areas in the specified storage device.

15. A data retaining method for a storage apparatus comprising:
a disk unit equipped with a plurality of storage devices; and
a disk controller for providing a plurality of host systems with a logical volume composed of storage areas in the plurality of storage devices;
wherein the data retaining method comprising:
a data transfer control step executed by a processor for the disk controller for transferring objective data to the disk unit in response to write requests from the plurality of host systems and transferring data stored in the disk unit to each of the plurality of host systems; and
a control step executed by the processor for the disk controller for executing the data transfer control step so that if any of the plurality of host systems issues a write request to write duplicate data as objective data which is identical to the stored data, part of the duplicate data will be kept in accordance with a specific rule instead of entirely eliminating writing the duplicate data.
